(19) United States
(12) Patent Application Publication
(10) Pub. No.: US 2025/0293863 A1
(43) Pub. Date: Sep. 18, 2025

(54) METHODS FOR IMPLEMENTING DISTRIBUTED KEY GENERATION IN BLOCKCHAIN, SYSTEMS, AND NODES

(71) Applicant: Ant Blockchain Technology (Shanghai) Co., Ltd., Shanghai (CN)

(72) Inventors: Li Lin, Hangzhou (CN); Wenbo Xu, Hangzhou (CN); Huanyu Ma, Hangzhou (CN); Ke Shi, Hangzhou (CN)

(73) Assignee: Ant Blockchain Technology (Shanghai) Co., Ltd., Shanghai (CN)

(21) Appl. No.: 19/194,842

(22) Filed: Apr. 30, 2025

Related U.S. Application Data
(63) Continuation of application No. PCT/CN2022/135591, filed on Nov. 30, 2022.

(30) Foreign Application Priority Data
Oct. 31, 2022 (CN) 202211347342.1

(51) Int. Cl. H04L 9/08; H04L 9/00; H04L 9/30; H04L 9/32

(52) U.S. Cl. CPC H04L 9/085; H04L 9/3013; H04L 9/3221; H04L 9/50

(57) ABSTRACT

A method for implementing distributed key generation in a blockchain by a blockchain node includes: generating n secret shares, retaining a share and respectively encrypting a remaining n−1 secret shares by using keys of receivers, generating a public verification parameter corresponding to a secret share of the blockchain node, generating a zero-knowledge proof indicating that the secret share of the blockchain node and the public verification parameter match, sending the secret share, the public verification parameter, and the zero-knowledge proof to an on-chain contract by using a transaction, verifying, by the on-chain contract based on the zero-knowledge proof, that the encrypted secret share and the public verification parameter match, obtaining, from contract information, a verified secret share corresponding to the blockchain node, performing decryption by using a key of the blockchain node, and calculating a private key share of the blockchain node based on a local secret share.

### CROSS-REFERENCE TO RELATED APPLICATIONS

This application is a continuation of PCT Application No. PCT/CN2022/135591, filed on Nov. 30, 2022, which claims priority to Chinese Patent Application No. 202211347342.1, filed on Oct. 31, 2022, and each application is hereby incorporated by reference in its entirety.

### TECHNICAL FIELD

Embodiments of this specification pertain to the field of blockchain technologies, and in particular, relate to methods for implementing distributed key generation in a blockchain, systems, and nodes.

### BACKGROUND

A blockchain is a novel application model of computer technologies such as distributed data storage, peer-to-peer transmission, consensus mechanisms, and encryption algorithms. In a blockchain system, data blocks are sequentially connected in a time sequence and combined into a chain data structure, and distributed ledgers that cannot be tampered with or forged are cryptographically ensured. The blockchain has characteristics such as decentralization, tamper-resistance of information, and autonomy, and therefore the blockchain has received increasing attention and applications.

### SUMMARY

An objective of the present invention is to provide methods for implementing distributed key generation in a blockchain, systems, and nodes, including the following:

A method for implementing distributed key generation in a blockchain includes the following:

S1: Each node generates n secret shares, retains one share, and respectively encrypts the remaining n−1 secret shares by using keys of receivers; each node generates a public verification parameter corresponding to the secret share of the node; and each node generates a third zero-knowledge proof indicating that the secret share of the node and the corresponding public verification parameter match.

S2: Each node sends the secret share, the public verification parameter, and the third zero-knowledge proof that are generated by the node to an on-chain contract by using the same transaction or different transactions.

S3: The on-chain contract verifies, by using the third zero-knowledge proof, that the encrypted secret share and the corresponding public verification parameter match.

S4: Each node obtains a verified secret share corresponding to a receiver that is the node from the contract information, performs decryption by using a key of the node, and calculates a private key share of the node with reference to a local secret share.

A method for implementing distributed key generation in a blockchain includes the following:

S1: Each node generates n secret shares, retains one share, respectively encrypts the remaining n−1 secret shares by using keys of receivers, and generates a corresponding first zero-knowledge proof that proves decryptability; each node generates a public verification parameter corresponding to the secret share of the node; and each node generates a third zero-knowledge proof indicating that the secret share of the node and the corresponding public verification parameter match.

S2: Each node can send the secret share, the corresponding first zero-knowledge proof, the public verification parameter, and the third zero-knowledge proof indicating that the secret share and the corresponding public verification parameter match to an on-chain contract in the same transaction or different transactions.

S3: The on-chain contract verifies the encrypted secret share by using the first zero-knowledge proof, and verifies, by using the third zero-knowledge proof, that the encrypted secret share and the corresponding public verification parameter match.

S4: Each node obtains a verified secret share corresponding to a receiver that is the node from the contract information, performs decryption by using a key of the node, and calculates a private key share of the node with reference to a local secret share.

A blockchain system includes several nodes.

Each node generates n secret shares, retains one share, and respectively encrypts the remaining n−1 secret shares by using keys of receivers; each node generates a public verification parameter corresponding to the secret share of the node; and each node generates a third zero-knowledge proof indicating that the secret share of the node and the corresponding public verification parameter match.

Each node sends the secret share, the public verification parameter, and the third zero-knowledge proof that are generated by the node to an on-chain contract by using the same transaction or different transactions.

The on-chain contract verifies, by using the third zero-knowledge proof, that the encrypted secret share and the corresponding public verification parameter match.

Each node obtains a verified secret share corresponding to a receiver that is the node from the contract information, performs decryption by using a key of the node, and calculates a private key share of the node with reference to a local secret share.

A blockchain system includes several nodes.

Each node generates n secret shares, retains one share, respectively encrypts the remaining n−1 secret shares by using keys of receivers, and generates a corresponding first zero-knowledge proof that proves decryptability; each node generates a public verification parameter corresponding to the secret share of the node; and each node generates a third zero-knowledge proof indicating that the secret share of the node and the corresponding public verification parameter match.

Each node can send the secret share, the corresponding first zero-knowledge proof, the public verification parameter, and the third zero-knowledge proof indicating that the secret share and the corresponding public verification parameter match to an on-chain contract in the same transaction or different transactions.

The on-chain contract verifies the encrypted secret share by using the first zero-knowledge proof, and verifies, by using the third zero-knowledge proof, that the encrypted secret share and the corresponding public verification parameter match.

Each node obtains a verified secret share corresponding to a receiver that is the node from the contract information, performs decryption by using a key of the node, and calculates a private key share of the node with reference to a local secret share.

A first node in a blockchain system is provided.

The first node generates n secret shares, retains one share, and respectively encrypts the remaining n−1 secret shares by using keys of receivers; the first node generates a public verification parameter corresponding to the secret share of the first node; and the first node generates a third zero-knowledge proof indicating that the secret share of the first node and the corresponding public verification parameter match.

The first node sends the secret share, the public verification parameter, and the third zero-knowledge proof that are generated by the first node to an on-chain contract by using the same transaction or different transactions.

The on-chain contract verifies, by using the third zero-knowledge proof, that the encrypted secret share and the corresponding public verification parameter match.

The first node obtains a verified secret share corresponding to a receiver that is the first node from the contract information, performs decryption by using a key of the first node, and calculates a private key share of the first node with reference to a local secret share.

A first node in a blockchain system is provided.

The first node generates n secret shares, retains one share, respectively encrypts the remaining n−1 secret shares by using keys of receivers, and generates a corresponding first zero-knowledge proof that proves decryptability; the first node generates a public verification parameter corresponding to the secret share of the first node; and the first node generates a third zero-knowledge proof indicating that the secret share of the first node and the corresponding public verification parameter match.

The first node can send the secret share, the corresponding first zero-knowledge proof, the public verification parameter, and the third zero-knowledge proof indicating that the secret share and the corresponding public verification parameter match to an on-chain contract in the same transaction or different transactions.

The on-chain contract verifies the encrypted secret share by using the first zero-knowledge proof, and verifies, by using the third zero-knowledge proof, that the encrypted secret share and the corresponding public verification parameter match.

The first node obtains a verified secret share corresponding to a receiver that is the first node from the contract information, performs decryption by using a key of the first node, and calculates a private key share of the first node with reference to a local secret share.

In the above-mentioned embodiments, for n nodes, a secret share generated by each node is encrypted and then sent to the on-chain contract, and message complexity is n. Therefore, peer-to-peer encrypted transmission between nodes is avoided, that is, message complexity of n² is avoided. It can be seen that a quantity of messages can be greatly reduced.

### BRIEF DESCRIPTION OF DRAWINGS

To describe the technical solutions in the embodiments of this specification more clearly, the following briefly describes the accompanying drawings needed for describing the embodiments. Clearly, the accompanying drawings in the following description are merely some embodiments of this specification, and a person of ordinary skill in the art can still derive other drawings from these accompanying drawings without creative efforts.

FIG. 1 is a schematic diagram illustrating a normal case phase of a practical Byzantine fault tolerance algorithm, according to some embodiments;

FIG. 2 is a schematic diagram illustrating a view change phase of a practical Byzantine fault tolerance algorithm, according to some embodiments;

FIG. 3 is a schematic diagram illustrating a normal case phase of a practical Byzantine fault tolerance algorithm when no consensus node is down, according to some embodiments;

FIG. 4 is a schematic diagram illustrating a structure of a block, according to some embodiments of this specification;

FIG. 5 is a flowchart illustrating generation of a random seed in a blockchain, according to some embodiments of this specification;

FIG. 6 is a schematic diagram illustrating a structure of a block header, according to some embodiments of this specification;

FIG. 7 illustrates a method for implementing distributed key generation in a blockchain, according to some embodiments of this specification;

FIG. 8 illustrates a method for implementing distributed key generation in a blockchain, according to some embodiments of this specification; and

FIG. 9 illustrates a method for implementing distributed key generation in a blockchain, according to some embodiments of this specification.

### DESCRIPTION OF EMBODIMENTS

To make a person skilled in the art better understand the technical solutions in this specification, the following clearly and comprehensively describes the technical solutions in the embodiments of this specification with reference to the accompanying drawings in the embodiments of this specification. Clearly, the described embodiments are merely some but not all of the embodiments of this specification. All other embodiments obtained by a person of ordinary skill in the art based on the embodiments of this specification without creative efforts shall fall within the protection scope of this specification.

A distributed key generation (DKG) protocol is a distributed protocol in which a group of keys are generated through collaboration between a plurality of participants participating in the protocol. A verifiable secret sharing (VSS) protocol is an important theoretical basis of the DKG protocol.

VSS means that during sharing of secret data between a plurality of participants, the secret data can be split into a plurality of shards without disclosing the secret data, and each of the plurality of participants keeps one shard. Then, when the secret data need to be restored, all the shards need to be collected to successfully restore the complete secret data.

The VSS protocol was first proposed by Shamir in 1979, and is a polynomial-based secret sharing protocol. The VSS protocol is developed from Shamir's secret sharing (SSS). Therefore, Shamir's secret sharing is first described.

Shamir's secret sharing includes two phases: secret sharing (or secret distribution) and secret reconstruction. A polynomial needs to be first constructed by a dealer:

f(x)=a₀+a₁x+a₂x2+ . . . +aₙxⁿ Polynomial (*)

Here, a₀ is to-be-shared secret data.

This polynomial of degree n is uniquely determined by a group of coefficients (a₀, a₁, a₂, . . . , aₙ), and this group of coefficients includes n+1 values. In this way, if it is known that a curve corresponding to the polynomial of degree n passes through n+1 different points on a plane, that is, coordinates (x₁,y₁), (x₂,y₂), . . . , (xₙ,yₙ), (xₙ₊₁,yₙ₊₁) of the n+1 different points are obtained, a system of (n+1)-variable linear equations of n+1 equations can be obtained. Therefore, values a₀, a₁, a₂, . . . , aₙ of the n+1 coefficients can be determined by using this system of equations, then the polynomial (*) is determined, and finally a value of the secret data a₀ can be obtained. The coordinates (x₁,y₁), (x₂,y₂), . . . , (xₙ,yₙ), (xₙ₊₁,yₙ₊₁) of the n+1 different points are n+1 secret shards.

A process of finding a curve passing through several existing points based on the points is referred to as polynomial interpolation. There are a plurality of methods for implementing polynomial interpolation. The following describes a common Lagrange interpolation method. Given a polynomial * of degree n, if it is known that a curve corresponding to the polynomial passes through coordinates (x₁,y₁), (x₂,y₂), . . . , (xₙ,yₙ), (xₙ₊₁,yₙ₊₁) of n+1 points on a plane, a polynomial of the curve of degree n can be obtained by using the Lagrange interpolation method as follows:

$$f ( x ) = \frac{( x - {x}_{2} ) ( x - {x}_{3} ) … ( x - {x}_{n} ) ( x - {x}_{n + 1} )}{( {x}_{1} - {x}_{2} ) ( {x}_{1} - {x}_{3} ) … ( {x}_{1} - {x}_{n} ) ( {x}_{1} - {x}_{n + 1} )} {y}_{1} + \frac{( x - {x}_{1} ) ( x - {x}_{3} ) … ( x - {x}_{n} ) ( x - {x}_{n + 1} )}{( {x}_{2} - {x}_{1} ) ( {x}_{2} - {x}_{3} ) … ( {x}_{2} - {x}_{n} ) ( {x}_{2} - {x}_{n + 1} )} {y}_{2} + … + \frac{( x - {x}_{1} ) ( x - {x}_{2} ) … ( x - {x}_{n - 1} ) ( x - {x}_{n + 1} )}{( {x}_{n} - {x}_{1} ) ( {x}_{n} - {x}_{2} ) … ( {x}_{n} - {x}_{n - 1} ) ( {x}_{1} - {x}_{n + 1} )} {y}_{n} + \frac{( x - {x}_{1} ) ( x - {x}_{2} ) … ( x - {x}_{n} ) ( x - {x}_{n + 1} )}{( {x}_{n + 1} - {x}_{1} ) ( {x}_{n + 1} - {x}_{2} ) … ( {x}_{n} - {x}_{n - 1} ) ( {x}_{n + 1} - {x}_{n} )} {y}_{n + 1} \qquad Polynomial ( * * )$$

The polynomial (**) and the polynomial (*) are essentially equivalent. If x=0 is set in the polynomial (*), f(0)=a₀, that is, the value of the secret data a₀ can be obtained. Therefore, if x=0 is set in the polynomial (**), the value of the secret data a₀ can also be obtained, that is, f(0)=a₀.

In conclusion, n+1 points on the polynomial can be randomly selected, and the n+1 points are shared between n+1 participants, for example, each participant obtains coordinates of one point. If coordinates of any fewer than n+1 points are collected, the original secret data a₀ cannot be inferred. Only after all the n+1 points are obtained, the value of the secret data a₀ can be restored by reconstructing polynomial coefficients. In addition, even if coordinates of any fewer than n+1 points are collected, for example, coordinates of n points, because there are countless curves of degree n passing through these n points, the value of the secret data a₀ is not disclosed in terms of probability. The degree n here is also referred to as a degree of the polynomial.

On this basis, threshold Shamir's secret sharing can be implemented. For example, t-of-n secret sharing is to share a secret between n participants and specify a threshold of t for a minimum quantity of secret shards needed for restoration. For example, in a transaction in which four parties participate, if an agreed threshold is 3, that is, n=4 and t=3, a secret can be restored only when at least three participants provide secret shards of the participants. Otherwise, the secret cannot be restored. Specifically, a polynomial of degree t−1=2 can be constructed:

$$f ( x ) = {a}_{0} + {a}_{1} x + {a}_{2} {x}^{2} \qquad Polynomial \text{(*} \text{**)}$$

It can be obtained that a curve corresponding to the polynomial of degree 2 passes through four different points on a plane, that is, coordinates (x₁,y₁), (x₂,y₂), (x₃,y₃), (x₄,y₄) of the four different points are obtained, and the coordinates of the four points are separately distributed to one participant in a secret sharing phase. The four participants are set to Party₁, Party₂, Party₃, and Party₄. In this way, assume that Party₁ has a shard (x₁,y₁), Party₂ has a shard (x₂,y₂), Party₃ has a shard (x₃,y₃), and Party₄ has a shard (x₄,y₄). The polynomial (***) can be determined by any three points on the corresponding curve. Therefore, in Partyᵢ(i∈{1, 2, 3, 4}), when any three participants provide secret shards of the participants, the polynomial (***) can be restored in a secret reconstruction phase, and a secret value a₀ can be obtained. When any fewer than three participants provide secret shards of the participants, the polynomial (***) cannot be restored, and the secret value a₀ cannot be obtained. The above-mentioned parameter t is also referred to as a threshold.

In the above-mentioned Shamir's secret sharing and threshold Shamir's secret sharing, a role for generating a polynomial and distributing secret shards is needed. This role can be referred to as a dealer. This dealer is an entity that knows the secret and needs to be a trusted third party of each participant. In addition, an entity for aggregating a threshold quantity of shards and obtaining the secret is further needed, for example, the dealer, a participant, or another entity.

In engineering practice, polynomials are usually defined in finite fields (based on elliptic curves or discrete logarithms) or prime fields (based on RSA) rather than real number fields or natural number fields.

In a classic Shamir's secret sharing scheme, assume that participants are honest. However, actually, there may be dishonest behavior or malicious behavior. For example, the dealer deceives one or more participants by sending an incorrect secret shard to the participant.

In secret sharing, verifiable secret sharing (VSS) is proposed to verify a malicious problem, for example, the participant verifying whether the dealer deceives the participant (verifying whether the dealer sends an incorrect secret shard, as described above). Feldman VSS is a practical VSS scheme constructed based on Shamir's secret sharing, including the following:

The dealer has a secret and distributes n shards of the secret to n participants. The secret can be reconstructed by t participants. A polynomial of degree t−1 can be constructed by using a scheme similar to the above-mentioned threshold Shamir's secret sharing scheme:

$$f ( x ) = {a}_{0} + {a}_{1} x + {a}_{2} {x}^{2} + … + {a}_{t - 1} {x}^{t - 1} \qquad Polynomial \text{(*} \text{***)}$$

The dealer randomly selects xᵢ that is not 0 for each participant Partyᵢ, calculates sᵢ=f(xᵢ), and sends the sub-secret sᵢ to the participant Partyⱼ through encryption. In addition, the dealer calculates Aⱼ=g^{a}^{ⱼ}, where j=0, 1, 2, . . . , and t−1, and discloses A₁, that is, discloses {A₀, A₁, A₂, . . . , Aₜ₋₁}. The parameter A₁ is referred to as a public verification parameter. A method for generating A₁ here is the same as a method for generating a public key based on a private key on an elliptic curve. Therefore, A₁ can also be referred to as a public key shard or a public key share.

For a case in which a selected polynomial corresponds to an elliptic curve, it is secure to disclose Aⱼ, because based on a property of the elliptic curve, aⱼ cannot be derived based on Aⱼ.

The public verification parameter {A₀, A₁, A₂, . . . , Aₜ₋₁} is also referred to as a commitment. The commitment can be used to verify whether a value of the polynomial is correct because a coefficient of the polynomial is bound to the commitment. In discrete logarithm-based implementations, g is a generator of a cyclic group in the finite field, and g can be preconfigured for the dealer and Partyᵢ. The above-mentioned sub-secret can also be referred to as a secret share.

After receiving the sub-secret sᵢ, the participant can verify validity of sᵢ by using the public verification parameter. Whether sᵢ is valid can be verified by verifying whether the following equation is true:

$${g}^{{s}_{i}} = {A}_{0}^{{x}_{i}^{0}} \cdot {A}_{1}^{{x}_{i}^{1}} \cdot … \cdot {A}_{t - 1}^{{x}_{i}^{t - 1}} \qquad Polynomial \text{(*} \text{****)}$$

A right side of the polynomial (*****) can be deduced as follows:

$${A}_{0}^{{x}_{i}^{0}} \cdot {A}_{1}^{{x}_{i}^{1}} \cdot … \cdot {A}_{t - 1}^{{x}_{i}^{t - 1}} = {( {g}^{{a}_{0}} )}^{{x}_{i}^{0}} \cdot {( {g}^{{a}_{1}} )}^{{x}_{i}^{1}} \cdot … \cdot {( {g}^{{a}_{t - 1}} )}^{{x}_{i}^{t - 1}}$$

$$= ( {g}^{{a}_{0} \cdot {x}_{i}^{0}} ) \cdot ( {g}^{{a}_{1} \cdot {x}_{i}^{1}} ) \cdot … \cdot ( {g}^{{a}_{t - 1} \cdot {x}_{i}^{t - 1}} )$$

$$= {g}^{{a}_{0} \cdot {x}_{i}^{0} + {a}_{1} \cdot {x}_{i}^{1} + … + {a}_{t - 1} \cdot {x}_{i}^{t - 1}}$$

$$= {g}^{{a}_{0} + {a}_{1} \cdot {x}_{i}^{1} + … + {a}_{t - 1} \cdot {x}_{i}^{t - 1}}$$

$$= {g}^{f ( {x}_{i} )} = {g}^{{s}_{i}}$$

The right side of the polynomial (*****) can also be written as g^{s}^{ᵢ}=Πₖ₌₀^{t-1}Aₖ^{x}^{ᵢ}^{^{k}}.

It can be seen that for Partyᵢ, the dealer selects xᵢ that is not 0, for example, xᵢ is i. In this case, Partyⱼ can calculate the right side of the polynomial (*****) by using i and the public verification parameter {A₀, A₁, A₂, . . . , Aₜ₋₁}, and calculate a left side of the polynomial (*****) by using generator g and the sub-secret sᵢ. Therefore, it can be determined, by determining whether the left and right sides of the polynomial (*****) are equal, whether (xᵢ, g^{s}^{ᵢ}) is a point on a curve corresponding to {A₀, A₁, A₂, . . . , Aₜ₋₁}. This verification is a verification in a secret distribution phase. For simplicity, xᵢ=i usually can be used.

In engineering, implementations are usually based on discrete logarithms, and a modulo operation such as modp is used for the above-mentioned formulas, where p is a large prime number, and p is also preconfigured for the dealer and Partyᵢ. The modulo operation modp is omitted in the following similar places.

In the secret reconstruction phase, for example, at least a threshold quantity of participants send secret shards of the participants to the dealer, and the dealer can verify each secret shard by using a public verification parameter corresponding to the polynomial. If the verification fails, it can be proved that a participant that sends the secret shard acts maliciously. A secret shard on which verification succeeds can be used as a basis for reconstructing the secret.

In the secret reconstruction phase, the participant can reconstruct a polynomial f(x) by using the Lagrange interpolation method, to obtain a value of f(0), that is, obtain a secret value.

In addition, validity of the secret a₀ can be verified by using the public verification parameter {A₀, A₁, A₂, . . . , Aₜ₋₁}, that is, it can be verified whether (0, a₀) is a point on the curve, because there is the following relationship:

$${A}_{0}^{{0}^{0}} \cdot {A}_{1}^{{0}^{1}} \cdot … \cdot {A}_{t - 1}^{{0}^{t - 1}} = {( {g}^{{a}_{0}} )}^{{0}^{0}} \cdot {( {g}^{{a}_{1}} )}^{{0}^{1}} \cdot … \cdot {( {g}^{{a}_{t - 1}} )}^{{0}^{t - 1}}$$

$$= ( {g}^{{a}_{0} \cdot {0}^{0}} ) \cdot ( {g}^{{a}_{1} \cdot {0}^{1}} ) \cdot … \cdot ( {g}^{{a}_{t - 1} \cdot {0}^{t - 1}} )$$

$$= {g}^{{a}_{0} \cdot {0}^{0} + {a}_{1} \cdot {0}^{1} + … + {a}_{t - 1} \cdot {0}^{t - 1}}$$

$$= {g}^{{a}_{0} \cdot 1 + {a}_{1} \cdot 0 + … + {a}_{t - 1} \cdot 0}$$

$$= {g}^{{a}_{0}} = {A}_{0}$$

$$= {g}^{f ( 0 )}$$

That is, the validity of the secret a₀ can be simplify verified by using the public verification parameter A₀.

In the above-mentioned deduction, 0⁰=1 is defined, and 0^{k}=0, k≠0.

In the above-mentioned scheme, a dealer is needed, and the dealer is centralized, and is an entity that knows the secret. As described above, the dealer needs to be a trusted third party, or the dealer needs to be trusted by participants. In a distributed scenario, both distributed secret distribution and distributed secret reconstruction need to be implemented. Therefore, the centralized dealer needs to be removed. In this way, trust removal is implemented. To resolve this problem, Rabin et al. proposed an improved protocol named Joint-Feldman in 1999. A basic idea of this protocol is to execute the Feldman VSS protocol n times in parallel. Each participant locally generates a random polynomial and then shares a randomly selected secret value between all the participants. A commitment of a secret rather than a secret is shared. Therefore, the secret cannot be restored provided that there is no collusion and cheating by a plurality of persons whose quantity exceeds the threshold t. Such a distributed VSS protocol in which the trusted third party is removed is also referred to as a distributed VSS (DVSS) protocol.

Specifically, four participants are used as an example. If the threshold is t=3, the degree of the polynomial is t−1=2, and a decentralized threshold secret sharing or Joint-Feldman implementation scheme includes the following:

Each Pᵢ (Partyᵢ is briefly written as Pᵢ, where i∈{1, 2, 3, 4}) sets a to-be-shared secret sᵢ₀ and randomly selects other parameters to generate a polynomial of degree t−1.

A participant P₁ generates a polynomial of degree 2:
f₁(z)=a₁₀+a₁₁z+a₁₂z², where a₁₀ is a secret s₁ set by P₁.

A participant P₂ generates a polynomial of degree 2:
f₂(z)=a₂₀+a₂₁z+a₂₂z², where a₂₀ is a secret s₂ set by P₂.

A participant P₃ generates a polynomial of degree 2:
f₃(z)=a₃₀+a₃₁z+a₃₂z², where a₃₀ is a secret s₃ set by P₃.

A participant P₄ generates a polynomial of degree 2:
f₄(z)=a₄₀+a₄₁z+a₄₂z², where a₄₀ is a secret s₄ set by P₄.

Then, each participant P₁ generates and distributes n values on a curve corresponding to the polynomial of degree t−1 of each participant. Here, still assume that n=4 and t=3, where n=1, 2, 3, 4.

The participant P₁ generates s₁₁=f₁(1), s₁₂=f₁(2), s₁₃=f₁(3), and s₁₄=f₁(4), retains s₁₁, sends s₁₂ to P₂ through encryption, sends s₁₃ to P₃ through encryption, and sends s₁₄ to P₄ through encryption.

The participant P₂ generates s₂₁=f₂(1), s₂₂=f₂(2), s₂₃=f₂(3), and s₂₄=f₂(4), retains s₂₂, sends s₂₁ to P₁ through encryption, sends s₂₃ to P₃ through encryption, and sends s₂₄ to P₄ through encryption.

The participant P₃ generates s₃₁=f₃(1), s₃₂=f₃(2), s₃₃=f₃(3), and s₃₄=f₃(4), retains s₃₃, sends s₃₁ to P₁ through encryption, sends s₃₂ to P₂ through encryption, and sends s₃₄ to P₄ through encryption.

The participant P₄ generates s₄₁=f₄(1), s₄₂=f₄(2), s₄₃=f₄(3), and s₄₄ f₄(4), retains s₄₄, sends s₄₁ to P₁ through encryption, sends s₄₂ to P₂ through encryption, and sends s₄₃ to P₃ through encryption.

In addition, each participant P₁ further generates a public verification parameter Aᵢₖ=g^{a}^{ᵢₖ} corresponding to the polynomial of degree t−1 of each participant, where k=0, 1, . . . , t−1, and publishes the public verification parameter to each participant. Details are as follows:

The participant P₁ generates A₁ₖ=g^{a}^{ᵢₖ}, where k=0, 1, . . . , t−1, including A₁₀=g^{a}^{ₜ₀}, A₁₁=g^{a}^{₁₁}, and A₁₂=g^{a}^{₁₂}, and broadcasts {A₁₀, A₁₁, A₁₂} to P₂, P₃, and P₄.

The participant P₂ generates A₂ₖ=g^{a}^{₂ₖ}, where k=0, 1, . . . , t−1, including A₂₀=g^{a}^{₂₀}, A₂₁=g^{a}^{₂₁}, and A₂₂=g^{a}^{₂₂}, and broadcasts {A₂₀, A₂₁, A₂₂} to P₁, P₃, and P₄.

The participant P₃ generates A₃ₖ=g^{a}^{₃ₖ}, where k=0, 1, . . . , t−1, including A₃₀=g^{a}^{₃₀}, A₃₁=g^{a}^{₃₁}, and A₃₂=g^{a}^{₃₂}, and broadcasts {A₃₀, A₃₁, A₃₂} to P₁, P₂, and P₄.

The participant P₄ generates A₄ₖ=g^{a}^{₄ₖ}, where k=0, 1, . . . , t−1, including A₄₀=g^{a}^{₄₀}, A₄₁=g^{a}^{₄₁}, and A₄₂=g^{a}^{₄₂}, and broadcasts {A₄₀, A₄₁, A₄₂} to P₁, P₂, and P₃.

In this way, after receiving s₂₁, P₁ can perform verification by using {A₂₀, A₂₁, A₂₂}; after receiving s₃₁, P₁ can perform verification by using {A₃₀, A₃₁, A₃₂}; and after receiving s₄₁, P₁ can perform verification by using {A₄₀, A₄₁, A₄₂}. A verification method is similar to the above-mentioned descriptions. Details are omitted for simplicity.

Similarly, after receiving s₁₂, P₂ can perform verification by using {A₁₀, A₁₁, A₁₂}; after receiving s₃₂, P₂ can perform verification by using {A₃₀, A₃₁, A₃₂}; and after receiving s₄₂, P₂ can perform verification by using {A₄₀, A₄₁, A₄₂}.

Similarly, after receiving s₁₃, P₃ can perform verification by using {A₁₀, A₁₁, A₁₂}; after receiving s₂₃, P₃ can perform verification by using {A₂₀, A₂₁, A₂₂}; and after receiving s₄₃, P₃ can perform verification by using {A₄₀, A₄₁, A₄₂}.

Similarly, after receiving s₁₄, P₄ can perform verification by using {A₁₀, A₁₁, A₁₂}; after receiving s₂₄, P₄ can perform verification by using {A₂₀, A₂₁, A₂₂}; and after receiving s₃₄, P₄ can perform verification by using {A₃₀, A₃₁, A₃₂}.

Assume that a participant set that is obtained after each participant performs verification and on which verification succeeds is set to Qual, and Qual={P₁, P₁, P₃, P₄} is set. In this case, P₁ locally holds secret shares s₁₁, s₂₁, s₃₁, and s₄₁ generated by different participants and public verification parameters {A₁₀, A₁₁, A₁₂}, {A₂₀, A₂₁, A₂₂}, {A₃₀, A₃₁, A₃₂}, and {A₄₀, A₄₁, A₄₂}; P₂ locally holds secret shares s₁₂, s₂₂, s₃₂, and s₄₂ generated by different participants and public verification parameters {A₁₀, A₁₁, A₁₂}, {A₂₀, A₂₁, A₂₂}, {A₃₀, A₃₁, A₃₂}, and {A₄₀, A₄₁, A₄₂}; P₃ locally holds secret shares s₁₃, s₂₃, s₃₃, and s₄₃ generated by different participants and public verification parameters {A₁₀, A₁₁, A₁₂}, {A₂₀, A₂₁, A₂₂}, {A₃₀, A₃₁, A₃₂}, and {A₄₀, A₄₁, A₄₂}; and P₄ locally holds secret shares s₁₄, s₂₄, s₃₄, and s₄₄ generated by different participants and public verification parameters {A₁₀, A₁₁, A₁₂}, {A₂₀, A₂₁, A₂₂}, {A₃₀, A₃₁, A₃₂}, and {A₄₀, A₄₁, A₄₂}.

Then, the participant P₁ can calculate that the secret share sᵢ is sᵢ=s₁+s₂₁+s₃₁+s₄₁; the participant P₂ can calculate that the secret share s₂ is s₂=s₁₂+s₂₂+s₃₂+s₄₂; the participant P₃ can calculate that the secret share s₃ is s₃=s₁₃+s₂₃+s₃₃+s₄₃; and the participant P₄ can calculate that the secret share s₄ is s₄=s₁₄+s₂₄+s₃₄+s₄₄.

Each participant Pᵢ can broadcast the secret share sᵢ calculated by the participant to another participant. After collecting at least a threshold quantity of secret shares, that is, t secret shares, in {s₁, s₂, s₃, s₄}, each participant Pᵢ can reconstruct the secret so. Here, for t=3, after collecting at least the threshold quantity of secret shares, equal to three secret shares, each participant Pᵢ can reconstruct the secret so.

This is because summation can be performed on the curves of all the participants to obtain a total curve:

$$f ( z ) = {f}_{1} ( z ) + {f}_{2} ( z ) + {f}_{3} ( z ) + {f}_{4} ( z ) \qquad Polynomial ( I )$$

$$f ( z ) = ( {a}_{10} + {a}_{11} z + {a}_{12} {z}^{2} ) + ( {a}_{20} + {a}_{21} z + {a}_{22} {z}^{2} ) + ( {a}_{30} + {a}_{31} z + {a}_{32} {z}^{2} ) + ( {a}_{40} + {a}_{41} z + {a}_{42} {z}^{2} )$$

$$f ( z ) = ( {a}_{10} + {a}_{20} + {a}_{30} + {a}_{40} ) + ( {a}_{11} + {a}_{21} + {a}_{31} + {a}_{41} ) z + ( {a}_{12} + {a}_{22} + {a}_{32} + {a}_{42} ) {z}^{2}$$

In this case, s₁=s₁₁+s₂₁+s₃₁+s₄₁=f(1)+f₂(1)+f₃(1)+f₄(1); s₂=s₁₂+s₂₂+s₃₂+s₄₂=f₁(2)+f₂(2)+f₃(2)+f₄(2); s₃=s₁₃+s₂₃+s₃₃+s₄₃=f₁(3)+f₂(3)+f₃(3)+f₄(3); and s₄=s₁₄+s₂₄+s₃₄+s₄₄=f₁(4)+f₂(4)+f₃(4)+f₄(4).

For the total curve f(z), there are the following relationships:

$$\begin{matrix}{s}_{1} = {f}_{1} ( 1 ) + {f}_{2} ( 1 ) + {f}_{3} ( 1 ) + {f}_{4} ( 1 ) = f ( 1 ) ; \\ {s}_{2} = {f}_{1} ( 2 ) + {f}_{2} ( 2 ) + {f}_{3} ( 2 ) + {f}_{4} ( 2 ) = f ( 2 ) ; \\ {s}_{3} = {f}_{1} ( 3 ) + {f}_{2} ( 3 ) + {f}_{3} ( 3 ) + {f}_{4} ( 3 ) = f ( 3 ) ; and \\ {s}_{4} = {f}_{1} ( 4 ) + {f}_{2} ( 4 ) + {f}_{3} ( 4 ) + {f}_{4} ( 4 ) = f ( 4 ) .\end{matrix}$$

The secret is s₀=a₁₀+a₂₀+a₃₀+a₄₀.

In this way, after each participant Pᵢ collects at least three of the secret shares s₁, s₂, s₃, and s₄, it is equivalent to that at least three points on a curve corresponding to the polynomial (I) are obtained, that is, at least three of four coordinates (x₁=1,y₁=s₁), (x₂=2,y₂=s₂), (x₃=3,y₃=s₃), (x₄=4,y₄=s₄) are obtained. Therefore, the total curve f(z) can be restored. Further, it can be calculated that f(0)=a₁₀+a₂₀+a₃₀+a₄₀=s₀, and therefore the secret s₀ can be obtained.

In addition, validity of the secret sᵢ can be verified by using the verification parameters {A₁₀, A₁₁, A₁₂}, {A₂₀, A₂₁, A₂₂}, {A₃₀, A₃₁, A₃₂}, and {A₄₀, A₄₁, A₄₂}, that is, it can be verified whether (0, sᵢ) is a point on the total curve. Specifically, the validity is determined by verifying whether the following equation is true:

$${g}^{{s}_{i}} = {\prod }_{j = 1}^{n} {\prod }_{k = 0}^{t - 1} {A}_{j k}^{{x}_{i}^{k}} \qquad Polynomial ( II )$$

This is because there is the following relationship:

$${\prod }_{j = 1}^{n} {\prod }_{k = 0}^{t - 1} {A}_{j k}^{{x}_{i}^{k}} = ( {A}_{10}^{{x}_{i}^{0}} \cdot {A}_{11}^{{x}_{i}^{1}} \cdot … \cdot {A}_{1 ( t - 1 )}^{{x}_{i}^{t - 1}} ) \cdot ( {A}_{20}^{{x}_{i}^{0}} \cdot {A}_{21}^{{x}_{i}^{1}} \cdot … \cdot {A}_{2 ( t - 1 )}^{{x}_{i}^{t - 1}} ) \cdot … \cdot ( {A}_{n 0}^{{x}_{i}^{0}} \cdot {A}_{n 1}^{{x}_{i}^{1}} \cdot … \cdot {A}_{n ( t - 1 )}^{{x}_{i}^{t - 1}} )$$

$$= ( {( {g}^{{a}_{10}} )}^{{x}_{i}^{0}} \cdot {( {g}^{{a}_{11}} )}^{{x}_{i}^{1}} \cdot … \cdot {( {g}^{{a}_{1 ( t - 1 )}} )}^{{x}_{i}^{t - 1}} ) \cdot ( {( {g}^{{a}_{20}} )}^{{x}_{i}^{0}} \cdot {( {g}^{{a}_{21}} )}^{{x}_{i}^{1}} \cdot … \cdot {( {g}^{{a}_{2 ( t - 1 )}} )}^{{x}_{i}^{t - 1}} ) \cdot … \cdot ( {( {g}^{{a}_{n 0}} )}^{{x}_{i}^{0}} \cdot {( {g}^{{a}_{n 1}} )}^{{x}_{i}^{1}} \cdot … \cdot {( {g}^{{a}_{n ( t - 1 )}} )}^{\cdot {x}_{i}^{t - 1}} )$$

$$= {g}^{( {a}_{10} \cdot {x}_{i}^{0} + {a}_{11} \cdot {x}_{i}^{1} + … + {a}_{1 ( t - 1 )} \cdot {x}_{i}^{t - 1} ) + ( {a}_{20} \cdot {x}_{i}^{0} + {a}_{21} \cdot {x}_{i}^{1} + … + {a}_{2 ( t - 1 )} \cdot {x}_{i}^{t - 1} ) + … + ( {a}_{n 0} \cdot {x}_{i}^{0} + {a}_{n 1} \cdot {x}_{i}^{1} + … + {a}_{n ( t - 1 )} \cdot {x}_{i}^{t - 1} )}$$

$$= {g}^{( {a}_{10} \cdot {x}_{i}^{0} + {a}_{20} \cdot {x}_{i}^{0} + … + {a}_{n 0} \cdot {x}_{i}^{0} ) + ( {a}_{11} \cdot {x}_{i}^{1} + {a}_{21} \cdot {x}_{i}^{1} + … {a}_{n 1} \cdot {x}_{i}^{1} ) + … + ( {a}_{1 ( t - 1 )} \cdot {x}_{i}^{t - 1} + {a}_{2 ( t - 1 )} \cdot {x}_{i}^{t - 1} + … {a}_{n ( t - 1 )} \cdot {x}_{i}^{t - 1} )}$$

$$= {g}^{( {a}_{10} + {a}_{20} + … + {a}_{n 0} ) + ( {a}_{11} + {a}_{21} + … {a}_{n 1} ) \cdot {x}_{i}^{1} + … + ( {a}_{1 ( t - 1 )} + {a}_{2 ( t - 1 )} + … {a}_{n ( t - 1 )} ) \cdot {x}_{i}^{t - 1}}$$

$$= {g}^{f ( {x}_{i} )}$$

$$= {g}^{{f}_{1} ( {s}_{i} ) + {f}_{2} ( {s}_{i} ) + … + {f}_{n} ( {s}_{i} )}$$

$$= {g}^{{s}_{1 i} + {s}_{2 i} + … + {s}_{n i}}$$

$$= {g}^{{s}_{i}}$$

Usually, assume that a right side of the equal sign of the polynomial (II) is a public key share, and is denoted as pubᵢ, i=1, 2, . . . , n, to verify a corresponding private key share:

$${pub}_{i} = {\prod }_{j = 1}^{n} {\prod }_{k = 0}^{t - 1} {A}_{j k}^{{x}_{i}^{k}}$$

As described above, usually, xᵢ=i for each i=1, 2, . . . , n can be used. In this way, i can be used as a number of each participant.

For verification of the secret s₀, that is, xᵢ=0, the above-mentioned formula can be further deduced as follows:

$${\prod }_{j = 1}^{n} {\prod }_{k = 0}^{t - 1} {A}_{j k}^{{x}_{0}^{k}} = ( {A}_{10}^{{x}_{0}^{0}} \cdot {A}_{11}^{{x}_{0}^{1}} \cdot … \cdot {A}_{1 ( t - 1 )}^{{x}_{0}^{t - 1}} ) \cdot ( {A}_{20}^{{x}_{0}^{0}} \cdot {A}_{21}^{{x}_{0}^{1}} \cdot … \cdot {A}_{2 ( t - 1 )}^{{x}_{0}^{t - 1}} ) \cdot … \cdot ( {A}_{n 0}^{{x}_{0}^{0}} \cdot {A}_{n 1}^{{x}_{0}^{1}} \cdot … \cdot {A}_{n ( t - 1 )}^{{x}_{0}^{t - 1}} )$$

$$= ( {A}_{10}^{{0}^{0}} \cdot {A}_{11}^{{0}^{1}} \cdot … \cdot {A}_{1 ( t - 1 )}^{{0}^{t - 1}} ) \cdot ( {A}_{20}^{{0}^{0}} \cdot {A}_{21}^{{0}^{1}} \cdot … \cdot {A}_{2 ( t - 1 )}^{{0}^{t - 1}} ) \cdot … \cdot ( {A}_{n 0}^{{0}^{0}} \cdot {A}_{n 1}^{{0}^{1}} \cdot … \cdot {A}_{n ( t - 1 )}^{{0}^{t - 1}} )$$

$$= ( {A}_{10}^{{0}^{0}} \cdot {A}_{20}^{{0}^{0}} \cdot … \cdot {A}_{n 0}^{{0}^{0}} ) \cdot ( {A}_{11}^{{0}^{1}} \cdot {A}_{21}^{{0}^{1}} \cdot … \cdot {A}_{n 1}^{{0}^{1}} ) \cdot … \cdot ( {A}_{1 ( t - 1 )}^{{0}^{t - 1}} \cdot {A}_{2 ( t - 1 )}^{{0}^{t - 1}} \cdot … \cdot {A}_{n ( t - 1 )}^{{0}^{t - 1}} )$$

$$= {( {A}_{10} \cdot {A}_{20} \cdot … \cdot {A}_{n 0} )}^{{0}^{0}} \cdot {( {A}_{11} \cdot {A}_{21} \cdot … \cdot {A}_{n 1} )}^{{0}^{1}} \cdot {( {A}_{1 ( t - 1 )} \cdot {A}_{2 ( t - 1 )} \cdot … \cdot {A}_{n ( t - 1 )} )}^{{0}^{t - 1}}$$

0⁰=1 is defined, and 0^{k}=0, k≠0. Therefore, the above-mentioned formula can be further deduced as follows:

$$= {( {A}_{10} \cdot {A}_{20} \cdot … \cdot {A}_{n 0} )}^{{0}^{0}} \qquad Polynomial ( III )$$

$$= {A}_{10} \cdot {A}_{20} \cdot … \cdot {A}_{n 0}$$

$$= {g}^{( {a}_{10} + {a}_{20} + … + {a}_{n 0} )}$$

$$= {g}^{f ( 0 )}$$

$$= {g}^{{s}_{0}}$$

It can be seen that validity of so can be verified based on the polynomial (III).

In addition, based on the deduction in the above-mentioned polynomial (III), verification of the validity of s₀ can be further reduced as follows:

$${g}^{{s}_{0}} = {\prod }_{i = 1}^{n} {A}_{i 0} \qquad Polynomial ( IV )$$

Usually, assume that a right side of the equal sign of the polynomial (IV) is a total public key, and is denoted as pub.

The above-mentioned Joint-Feldman protocol can implement distributed secret sharing, that is, complete main content of DKG. The above-mentioned protocols from Shamir to threshold Shamir, the Feldman VSS protocol, and the Joint-Feldman DVSS protocol are a series of secret sharing implementation schemes. Actually, in addition to the series of schemes starting with Shamir's secret sharing, there are schemes based on additive secret sharing, SPDZ (an important protocol in secure multi-party computation, first proposed in 2012), the Chinese remainder theorem, etc., which can ultimately implement DKG. These schemes are omitted here and are not described.

Through implementation of the above-mentioned DKG protocol, a problem of overall unavailability caused by a fault in a single node when a single entity generates a key and a problem of a need to trust the single node that generates the key can be overcome. However, because each participant Pᵢ broadcasts a generated secret share sᵢⱼ, where i, j∈(1, 2, . . . , n), and n is a quantity of participants, and each participant Pᵢ can broadcast a secret share sᵢ calculated by the participant to another participant, each participant Pᵢ can reconstruct a secret so after collecting at least a threshold quantity of secret shares, that is, t secret shares, in {s₁, s₂, s₃, s₄}. Consequently, at least a threshold quantity of participants obtain the finally reconstructed secret, that is, the secret s₀ is exposed, and a total curve becomes unavailable. If a new secret so needs to be generated next time, a process of executing the DKG protocol needs to be repeated.

Properties of the DKG protocol in terms of threshold and secret commitments, combined with a matching threshold signature algorithm, can be used to construct a distributed threshold signature protocol. As a distributed system, a blockchain uses a large quantity of signature algorithms. In this way, nodes in the blockchain generate secret shares in a distributed way through DKG, and after at least a threshold quantity of blockchain nodes sign to-be-signed information by using secret shares as private key shares and broadcast the information, any blockchain node that collects at least a threshold quantity of signature shares can restore a total signature, and can restore a total public key by the above-mentioned method, and the restored total signature can be verified by using the total public key, to implement a threshold signature. In addition, an advantage of this is that a secret share held by each blockchain node does not need to be broadcast to another node, and therefore the secret share of each blockchain node is not exposed and a private key is not exposed. Therefore, a secret share generated at a time through DKG can be repeatedly used a plurality of times, and there is no need to execute the DKG protocol for each threshold signature.

A blockchain, a smart contract, a consensus mechanism, and other basic content are described below.

The blockchain 1.0 era usually refers to a development phase of blockchain applications represented by bitcoin between 2009 and 2014, and is mainly focused on resolving decentralization of currency and payment methods. Since 2014, developers have increasingly focused on addressing technical and scalability deficiencies of bitcoins. At the end of 2013, Vitalik Buterin released the Ethereum white paper “Ethereum: A Next-Generation Smart Contract and Decentralized Application Platform”, introducing smart contracts into the blockchain and opening up applications of the blockchain beyond the currency field, thus ushering in the blockchain 2.0 era.

In a blockchain system, different participants can establish a distributed blockchain network by using deployed nodes. A decentralized (or multi-centralized) distributed ledger constructed using a chain block structure is stored on each node (or most nodes, for example, consensus nodes) in the distributed blockchain network Such a blockchain system needs to resolve a problem of consistency and correctness of respective ledger data on a plurality of decentralized (or multi-centralized) nodes. Each node (or a plurality of nodes) runs a blockchain program, and under a design of specific fault tolerance needs, a consensus mechanism is used to ensure that all loyal nodes have the same transactions, so as to ensure that all the loyal nodes achieve consistent execution results for the same transactions, and package the transactions and the execution results into blocks.

A smart contract is a computer contract that is based on a specified trigger rule and that can be executed automatically, and can also be considered as a digital version of a conventional contract. The concept of smart contract was first proposed by Nick Szabo, an interdisciplinary legal scholar and cryptography researcher, in 1994. This technology was not used in real-world industries due to a lack of programmable digital systems and related technologies until the emergence of blockchain technology and Ethereum provided a reliable execution environment to this technology. The blockchain technology uses a block chaining ledger, generated data cannot be tampered with or deleted, and new ledger data are continuously added to the entire ledger, thereby ensuring traceability of historical data. In addition, a decentralized operation mechanism avoids impact of centralized factors. Smart contracts based on the blockchain technology not only can give full play to advantages of the smart contracts in terms of cost and efficiency, but also prevent malicious behavior from interfering with normal contract execution. The smart contract is written into the blockchain in a digital form, and characteristics of the blockchain technology ensure that an entire process of storage, reading, and execution is transparent and traceable, and cannot be tampered with.

The development and applications of the blockchain are diversified. Some service logic is edited into smart contracts and executed on a blockchain platform. Specifically, these smart contracts that include service logic can run on each node (or most nodes, for example, consensus nodes) in the blockchain network. Different from a centralized service logic execution environment in which an entire centralized system is unavailable due to a fault in a single node, execution of smart contracts in a blockchain environment is also referred to as a “world computer”. This is because there are many nodes in the distributed blockchain network that independently execute smart contracts As described above, smart contracts executing the same logic on these different nodes need to obtain the same execution result to ensure that ledgers stored on most of these nodes are consistent.

In some service logic, a result may need to be generated based on a random number, for example, service logic for implementing prize drawing, service logic for implementing a lottery, or service logic for sending red envelopes or blind boxes with random amounts within a specific range. In this case, a program for generating a random number usually needs to be included in the smart contract. For another example, in some system contracts, there may be a need to implement voting for primary nodes or small-scale committees, and a random method or a random number may be used in the voting logic. As described above, a notable characteristic of the distributed blockchain network is that to ensure the overall availability of the distributed blockchain network, ledgers on most nodes need to be consistent, which means that random numbers generated by smart contracts on most nodes need to be consistent.

As described above, each node (or a plurality of nodes) runs a blockchain program, and under a design of specific fault tolerance needs, a consensus mechanism is used to ensure that all loyal nodes have the same transactions, so as to ensure that all the loyal nodes achieve consistent execution results for the same transactions, and package the transactions and the execution results into blocks. Current mainstream consensus mechanisms include a proof of work (PoW), a proof of stake (PoS), a delegated proof of stake (DPoS), a practical Byzantine fault tolerance (PBFT) algorithm, a HoneyBadger Byzantine fault tolerance (HoneyBadger BFT) algorithm, etc.

PBFT is used as an example. The algorithm was proposed by Miguel Castro and Barbara Liskov in 1999, resolves a problem of low efficiency of an original Byzantine fault tolerance algorithm, and reduces algorithm complexity from an exponential level to a polynomial level, making the Byzantine fault tolerance algorithm feasible in practical system applications. This paper was published at the 1999 ACM Symposium on Operating Systems Design and Implementation (OSDI99). In the PBFT algorithm, all replicas run in succession of configuration named a view. In a view, one replica serves as a primary node and other replicas serves as backup nodes. Views are consecutively numbered numbers. The primary node can be calculated by using a formula p=v mod|R|, where v is a view number, p is a replica number, and |R| is a quantity of replica sets. In this algorithm, assume that when a maximum of f replicas (that is, nodes) fail, security and activity can be ensured in an asynchronous system if a total of at least 3f+1 replicas are present. A set of a specific quantity of replicas needed to ensure data consistency and fault tolerance needs for all replicas is usually a set including most nodes in a distributed system, forming a quorum. For example, when a total quantity n of nodes is 3f+1 (n=3f+2 or n=3f can also exist, but these cases usually do not improve fault tolerance effects), the quorum is 2f+1. In this way, for a distributed system that includes four nodes, any three nodes can form a quorum; for a distributed system that includes seven nodes, any five nodes can form a quorum; and so on.

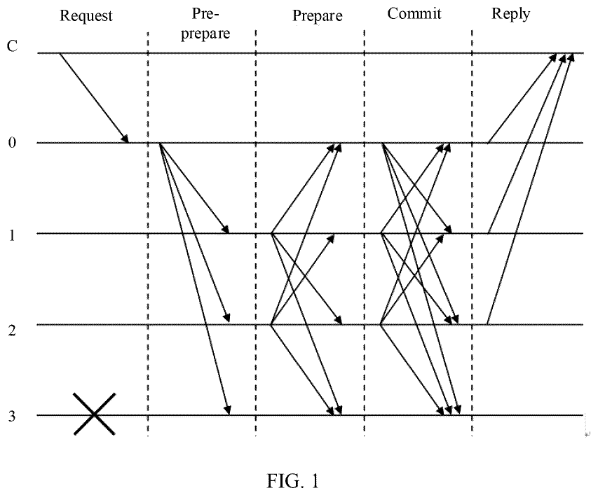

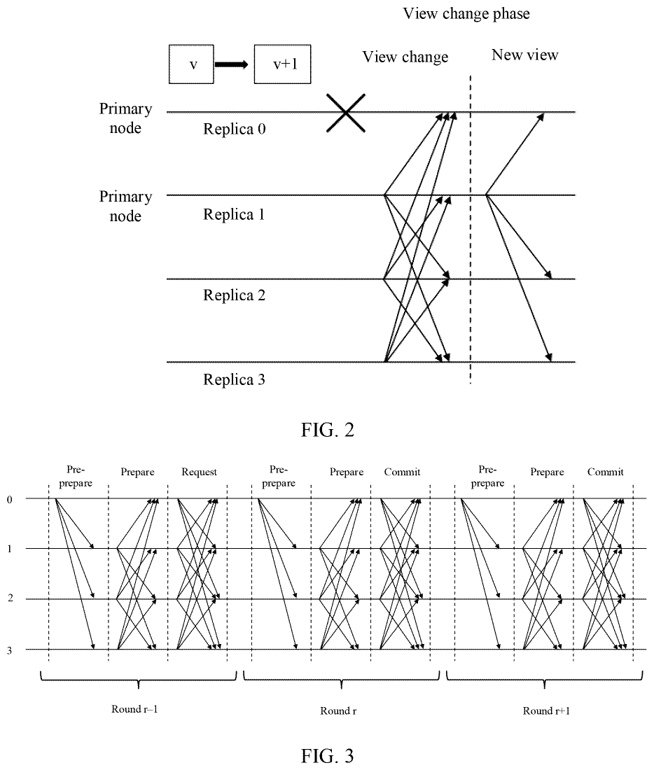

PBFT includes two processes: a normal case phase and a view change phase. FIG. 1 is a flowchart illustrating a normal case phase process. The normal case phase mainly includes three phases: pre-prepare, prepare, and commit. A node 3 can represent, for example, a down node (indicated by x in FIG. 1). When the primary node fails (indicated by x in FIG. 2, for example, when the primary node, that is, a replica 0, fails before view change), the view change process needs to be started. Therefore, when the system is faulty, adjustment is performed to obtain a new primary node (for example, a replica 1 is the primary node after view change). FIG. 2 is a schematic diagram illustrating a view change phase. If the primary node goes offline or acts maliciously and does not broadcast a request of a client device, the client device can set a timeout mechanism. If timeout occurs, the client device can broadcast a request message to all replica nodes. After detecting that the primary node acts maliciously or goes offline, the replica node can initiate a view change protocol phase to change the primary node (usually briefly referred to as “change the primary). In addition, a consensus process in the three phases of pre-prepare, prepare, and commit may fail due to an incorrect proposal initiated by the primary node, or an agreement on the quorum quantity (for example, 2f+1 in 3f+1 nodes) may not be reached in the prepare and commit phases, that is, the consensus cannot be completed. In these cases, the view change protocol phase can also be initiated to change the primary node.

In a normal case, that is, when no consensus node is down, a consensus message can reach the other party within a specific time, that is, no case of primary change occurs. The normal case phase process in PBFT can be shown in FIG. 3. In the figure, four consensus nodes are still used as an example.

In a normal case phase process in a round r−1, after collecting a specific quantity of to-be-agreed transactions (or read/write sets, where transactions are subsequently used as an example for description) as the primary node, a node 0 initiates a pre-prepare process (that is, the above-mentioned pre-prepare phase, also briefly referred to as a PP phase), then nodes 1, 2, and 3 enter a prepare process (that is, the above-mentioned prepare phase, also briefly referred to as a P phase), and then the nodes 0, 1, 2, and 3 enter a commit process (that is, the above-mentioned commit phase, also briefly referred to as a C phase). The PP phase, the P phase, and the C phase are usually jointly referred to as three phases in PBFT. In this way, in a normal case, a three-phase process in the round r−1 of PBFT is completed, that is, a consensus on transaction data corresponding to an (m−1)^{th} block is completed, and blockchain platform code can generate information such as a block number of the corresponding block. Therefore, each consensus node can sequentially execute these transactions based on the agreed transaction data and a sequence and content of the agreed transaction data, to generate a world state and a receipt. Specifically, each node can locally construct a Merkle tree (including a tree structure such as an MPT tree, where MPT is short for Merkle Patricia Tree, and is a tree structure that combines the Merkle tree and a Patricia tree (compact prefix tree or a trie tree that saves more space)) based on the agreed transaction data, and generate a hash (also referred to as a transaction root hash) of a tree root of the Merkle tree. Similarly, each node can construct a Merkle tree based on world state data, and generate a hash (also referred to as a state root hash) of a tree root of the Merkle tree; and can construct a Merkle tree based on receipt data, and generate a hash (also referred to as a receipt root hash) of a tree root of the Merkle tree. After locally generating the three root hashes, each node can locally generate the (m−1)^{th} block. A block header of the (m−1)^{th} block can include information such as the above-mentioned block number, the transaction root hash, the state root hash, and the receipt root hash, and a block body can include a transaction data set, a world state set, and a receipt set. In this way, the (m−1)^{th} block is generated.

In a process of generating an m^{th} block, the three-phase process in PBFT is repeated. As shown in FIG. 3, for the m^{th} block, after collecting a specific quantity of to-be-agreed transactions as the primary node, the node 0 initiates the PP process, then the nodes 1, 2, and 3 enter the P process, and then the nodes 0, 1, 2, and 3 enter the C process. In this way, in a normal case, a three-phase process in a round r of PBFT is completed, that is, a consensus on transaction data corresponding to the m^{th} block is completed, and information such as a block number of the block is generated. Each node can sequentially execute these transactions based on the agreed transaction data and a sequence and content of the agreed transaction data, to generate a world state and a receipt. After locally generating the three root hashes described above, each node can locally generate the m^{th} block. A block header of the m^{th} block can include information such as the above-mentioned block number, the transaction root hash, the state root hash, and the receipt root hash, and a block body can include a transaction data set, a world state set, and a receipt set. In this way, the m^{th} block is generated. Similarly, a process of generating an (m+1)^{th} block includes a three-phase process in a round r+1 round of PBFT shown in FIG. 3.

It can be seen that when a block is normally generated, each consensus node includes one normal case phase process in PBFT in a process of generating each block. As blocks are continuously generated, each consensus node repeats this consensus process. Only consensus processes in the round r−1, the round r, and the round r+1 round are shown as examples in FIG. 3. Some consensus nodes serve as primary nodes in PBFT, and some consensus nodes serve as backup nodes in PBFT.

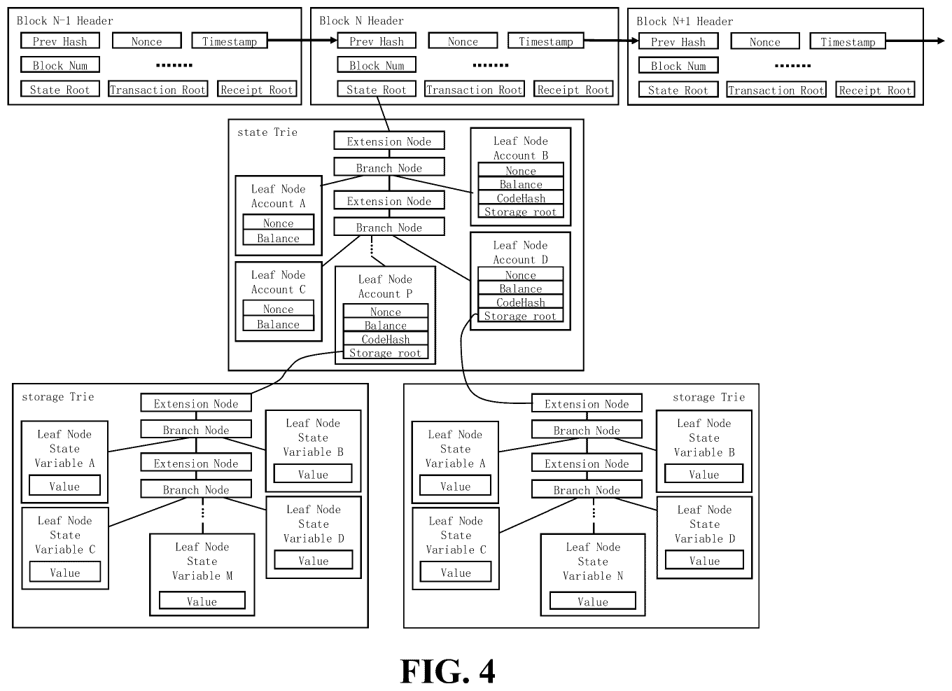

Ethereum is used as an example. FIG. 4 is a schematic diagram illustrating a structure of a block header of a block. In the structure shown in FIG. 4, a block header of each block includes several fields, for example, a previous block hash previous_Hash (Prev Hash in the figure), a nonce (this is a random number involved in the proof of work and is different from a random seed in this application, and this nonce is not enabled in some Ethereum-based consortium blockchains), a timestamp Timestamp, a previous block number Block Num, a state root hash State Root, a transaction root hash Transaction Root, and a receipt root hash Receipt Root. Prev Hash in a block header of a next block (for example, a block N+1) points to a current block (for example, a block N), that is, a hash value of the current block, that is, a hash value of a block header of the current block. The hash value of the block header can be a hash value calculated by using a certain hash algorithm after all fields included in the block header are sequentially concatenated. In this way, locking of the next block to the current block is implemented in the blockchain through the block header. In particular, as described above, State Root is a root hash of a world state, that is, a hash value of a root of an MPT tree including states of all accounts, and a state tree state trie in a form of an MPT points to state_root. Transaction Root is usually a hash value of a tree root node after an original transaction list included in the block is organized into a tree structure. Receipt Root is usually a hash value of a tree root node after all receipts generated after transactions included in the block are executed are organized into a tree structure. A transaction tree and a receipt tree in the block body can have structures similar to that of the state tree. Details are omitted here.

Here, r−1 in FIG. 3 can correspond to N−1 in FIG. 4, r in FIG. 3 can correspond to N in FIG. 4, r+1 in FIG. 3 can correspond to N+1 in FIG. 4, and so on.

One consensus process, that is, a three-phase process in one round of PBFT, can include the following:

a110: (Pre-prepare phase) After collecting a specific quantity of to-be-agreed transactions, the primary node 0 sorts and packages the to-be-agreed transactions into a message m (also referred to as an original transaction list), and sends a pre-prepare request to the backup nodes 1, 2, and 3, where the pre-prepare request includes the original transaction list.

a120: (Prepare phase) After the pre-prepare request is received, if it is checked that the original transaction list is valid, the nodes 1, 2, and 3 respectively broadcast, by using prepare messages, a hash value of the message m received by the nodes 1, 2, and 3 (broadcast content usually does not include the message m because the message m includes several original transaction requests and usually has a relatively large volume). Specifically, the node 1 diffuses the prepare message to the nodes 0, 2, and 3, the node 2 diffuses the prepare message to the nodes 0, 1, and 3, and the node 3 diffuses the prepare message to the nodes 0, 1, and 2. Correspondingly, each node further receives a prepare message broadcasted by another node. Each node adds the prepare message (including the hash value of the message m, representing approval of the node) sent by the node and the received prepare message (including the hash value of the message m, representing approval of the another node) to a local log. If a node collects at least a quorum quantity of valid pp message/p messages (including pre-prepare and prepare messages sent by the node and a received prepare message) from different nodes, the node changes to a prepared state.

a130: (Commit phase) After entering the prepared state, each node that participates in the consensus sends a commit message to another consensus node, and adds the commit message sent by the node to the local log (representing approval of the node), and each node further receives a commit message broadcast by another node. If a node collects at least a quorum quantity of valid commit messages from different nodes and adds the messages to the local log (in this case, there are a total of a quorum quantity of messages including the message added by the node to the local log), the node changes to a committed state.

a140: The node in the committed state outputs the message m as a consensus result of the current round.

Specific transactions included in the message m and a sequence of the included transactions are usually determined by the primary node in a110. Determining specific included transactions and determining a sequence of the included transactions are important content of the consensus mechanism. Many transaction requests may be received in the blockchain network. Specific transactions to be processed by the blockchain network are determined based on specific transactions packaged by the primary node in a110, and a transaction execution result is linked. Even for the same group of transactions, final results are different in cases of different sequences. This affects consistency between ledgers on all the nodes.

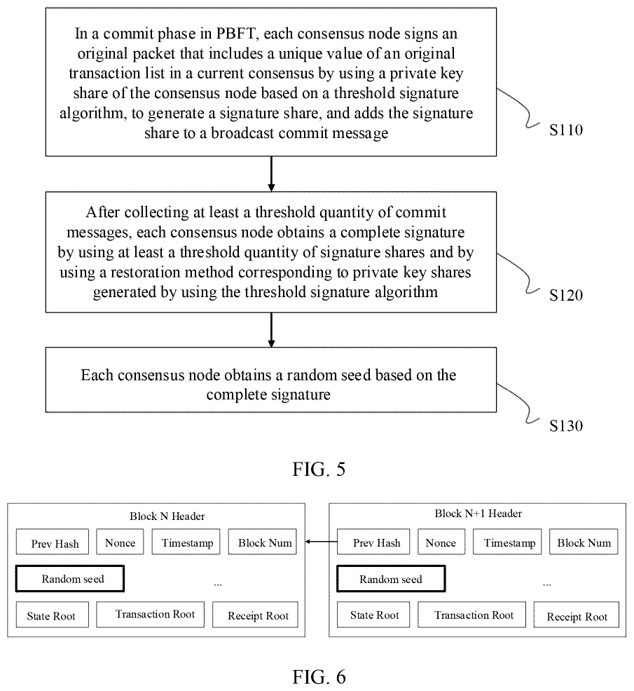

This application provides a method for generating a random seed in a blockchain. The method can be implemented with reference to the above-mentioned three-phase process in PBFT. As shown in FIG. 5, the method includes the following steps.

S110: In a commit phase in PBFT, each consensus node signs an original packet that includes a unique value of an original transaction list in a current consensus by using a private key share of the consensus node based on a threshold signature algorithm, to generate a signature share, and adds the signature share to a broadcast commit message.

A threshold signature is an important branch of a common digital signature, and is a combination of a threshold secret sharing technology and a digital signature. Common threshold signature algorithms can include an RSA-based threshold signature algorithm, an ECDSA-based threshold signature algorithm, a Schnorr-based threshold signature algorithm, a BLS-based threshold signature algorithm, etc. For example, an RSA-based threshold signature scheme is implemented based on a conventional RSA algorithm.

The RSA algorithm is an asymmetric encryption algorithm proposed in 1977 by Ron Rivest, Adi Shamir, and Leonard Adleman. The RSA algorithm can complete decryption without directly transferring a key. This can ensure information security and avoid a risk that information is cracked because a key is directly transferred. RSA includes a private key and a public key, and the private key and the public key are paired. After information is encrypted by using the public key, decryption can be performed only by using the corresponding private key. Similarly, after information is encrypted by using the private key, decryption can be performed only by using the corresponding public key. There is such as a property because the paired private and public keys are related in mathematical principles. For example, an underlying principle is that based on a number theory, it is relatively easy to find two large prime numbers, but it is very difficult to factor a product of the two large prime numbers. Therefore, the product can be disclosed as an encryption key to ensure security. The private key is usually kept strictly confidential and cannot be disclosed, while the public key is disclosed (and can be held by a plurality of persons). Because the private key is kept strictly confidential by a holder, others cannot forge a signature of the private key holder without obtaining the private key.

The RSA-based signature mechanism ensures integrity of a packet transfer process. For example, if a node A needs to send a packet to a node B, and forwarding may need to be performed through several intermediate nodes, A can use the RSA-based signature mechanism to transfer the packet together with a signature to B through the several intermediate nodes. Through verification of the signature by B, it can be ensure that the received packet is sent by A and is not tampered with in a transfer process. An RSA signature process is as follows:

b1: A generates a pair of keys (a public key and a private key). The private key is not disclosed and is retained. The public key is disclosed and can be obtained by anyone.

b2: A signs a hash value of an original packet by using the private key of A, and transfers the original packet together with a signature result to B. As described above, in this transfer process, forwarding may need to be performed through several intermediate nodes.

A hash algorithm is also referred to as a hashing algorithm, and can map original content into a fixed-length sequence. The sequence is a hash value. Usually, there are hash algorithms such as SHA-256, SHA-384, and SHA-512. A result of SHA-256 is 256 bits, which can represent 2 to the power of 256 pieces of original content. Similarly, a result of SHA-384 is 384 bits, and a result of SHA-512 is 512 bits. These hash algorithms can be used for original content with a relatively large volume. Therefore, the hash value can be relatively much smaller than the original content. A good hash algorithm can ensure that it is highly probable that different original content is mapped into different hash values. In addition, the mapping is random, that is, a correlation between hash values obtained by using different original content cannot be predicted; and is resistant to an inverse operation, that is, the original content cannot be inferred from the hash value.

The original packet may have a relatively large amount of content and a relatively large volume, and directly signing the original packet with the private key may be time-consuming and computationally intensive. Therefore, the original packet can be calculated by using a hash algorithm, to obtain a hash value. In this way, the hash value has a relatively short length, and can completely represent the original packet. Further, encryption calculation is performed on the hash value by using the private key, and an obtained result is a signature.

b3: After receiving the message, B verifies the signature by using the public key of A.

B can calculate a hash value, denoted as hash1, of the original packet by using a hash algorithm that is the same as that of A. In addition, B performs decryption calculation on the signature result by using the public key of A, to obtain hash2. If hash1 is the same as hash2, it can be determined that the received original packet is sent by A, and is not tampered with in a transfer process.

The threshold signature scheme first includes one total public key and n public-private key pairs. One public key in each public-private key pair is referred to as a public key share, and one private key in each public-private key pair is referred to as a private key share. In addition, there is a restoration function corresponding to the total public key and the n public-private key pairs. The restoration function can restore signature shares signed by using at least a threshold quantity of different private key shares to a complete signature. Correctness of the generated complete signature can be verified by the one total public key. However, any quantity of signature shares less than the threshold quantity cannot be restored to generate the complete signature.

In addition to the RSA-based threshold signature mechanism, an elliptic curve digital signature algorithm (ECDSA)-based threshold signature mechanism, a Schnorr (a knowledge proof mechanism based on a discrete logarithm problem)-based threshold signature mechanism, a Boneh-Lynn-Shacham (BLS)-based threshold signature mechanism, etc. can be used.

It is worthwhile to note that for threshold signatures used in the blockchain, a quantity of private key shares can be equal to a quantity of consensus nodes, and a minimum quantity (that is, a threshold quantity) of signature shares needed by the restoration function to generate a complete signature can be equal to the quorum in the PBFT algorithm. Certainly, a quantity of private keys may not be equal to a quantity of consensus nodes, and a minimum quantity of signature shares needed by the restoration function to generate a complete signature may not be equal to the quorum in the PBFT algorithm. The following uses the former an example for description.

The one total public key and the n public-private key pairs can be generated by a centralized dealer and distributed to n blockchain consensus nodes. This is a centralized key allocation method. In this way, with reference to the consensus algorithm, each blockchain consensus node can hold one of n private key shares. In addition, each blockchain consensus node can hold the same one total public key. In addition, there is a decentralized key allocation method. That is, the dealer is removed, the n consensus nodes obtain n public-private key pairs and one total public key through negotiation by using a key negotiation process, each consensus node still independently holds one of the n private key shares, and each consensus node holds the same total public key.

By using the threshold signature algorithm, each consensus node can sign the original packet that includes the unique value of the original transaction list in the current consensus by using a unique private key of the node (for example, in a blockchain network that includes four nodes and uses PBFT as a consensus algorithm, private key shares held by a node 0, a node 1, a node 2, and a node 3 by using the threshold signature algorithm are sk₀, sk₁, sk₂, and sk₃, where the subscript number can represent a number of the node), to obtain a signature result. Here, the unique value of the original transaction list can be used as the original packet to which the signature is directed.

The unique value of the original transaction list can include the original transaction list or a hash value of the original transaction list. Usually, different transactions have different transaction content. In this way, different original transaction lists or hash values of different original transaction lists are usually different. Therefore, the original packet can include at least the original transaction list or the hash value of the original transaction list. In this way, properties of the hash function are sufficient to distinguish between random seeds generated after consensus processes corresponding to different blocks are completed.

Considering that a number is generated for content of the current consensus in the consensus process, if the consensus is completed, the generated number can be used as a block number of a block corresponding to the current consensus. Therefore, the block number (that is, the number) can also be used as content of the original packet. Regardless of whether an original transaction list included in the (N+1)^{th} block is the same as an original transaction list included in the N^{th} block, blocks are sequentially generated, which can be embodied as that a block number of a next block is a block number of a current block plus 1. Therefore, the block number is used as content of the original packet. Even if the original transaction list included in the (N+1)^{th} block is the same as the original transaction list included in the N^{th} block, each node still obtains a different signature by using the private key of the node based on (the original transaction list+the block number), and the primary node still cannot learn of a signature of another node and therefore cannot predict a complete signature of the (N+1)^{th} block. Therefore, the primary node cannot predict a random seed of the (N+1)^{th} block by using a disclosed random seed of the N^{th} block, thereby achieving an unpredictability objective. Similar to the number, a timestamp is also unique to a block, and a timestamp of the next block is after that of the current block. Therefore, the timestamp can also be used as content of the original packet.

In addition to the unique value of the original transaction list, other content can be added as a to-be-signed object, for example, a random seed generated in the previous block, that is, the original packet can further include the random seed generated in the previous block. After a140 is performed, as described above, each node can generate the m^{th} block based on the agreed transaction data. Because the m^{th} block is locally and independently generated by each node, if hash values of previous blocks generated by blockchain nodes are not broadcast to each other and compared with each other, each node possibly cannot determine whether the m^{th} blocks generated in the blockchain network are the same, or whether m^{th} blocks generated on at least a quorum quantity of consensus nodes are the same in terms of overall availability of the blockchain system. After the process of generating the random seed in this application is performed, random seeds of the same block should be the same, and random seeds of different blocks should be different. Therefore, the random seed can be added to the original packet. In this way, if random seeds corresponding to the m^{th} blocks respectively generated by all the nodes are different, based on the property of the threshold signature algorithm, a complete signature possibly cannot be obtained by using the restoration function in a process of generating a random seed in the (m+1)^{th} block. Therefore, according to the solution of this application, the consensus node can be assisted in determining whether the previous blocks are consistent. Alternatively, a hash value of the previous block can be used to replace a random seed of the previous block. Because a hash value of one block is usually unique, the consensus node can be assisted in determining whether the previous blocks are consistent.

The original packet that includes the unique value of the original transaction list in the current consensus is signed by using the private key share of the node. The unique value of the original transaction list that can be included in the original packet can be the original transaction list. The original transaction list usually has been broadcast in the PP phase in PBFT, and propagation and bandwidth saving are further facilitated if a relatively small commit message is broadcast in the C phase. Therefore, the unique value of the original transaction list can be the hash value of the original transaction list.

When the original packet includes a plurality of pieces of content, for example, includes the hash value of the original transaction list, the block number, and the random seed generated in the previous block, the hash value of the original packet can be first calculated, and then the hash value of the original packet is signed by using the private key share, to obtain a signature result.

The original packet is signed, and the generated signature result together with the original packet can be added to the broadcast commit message. In this way, in the commit phase, each node that participates in the consensus sends a commit message to another consensus node, and adds the commit message sent by the node to the local log (representing approval of the node), and each node further receives a commit message broadcast by another node.

S120: After collecting at least a threshold quantity of commit messages, each consensus node obtains a complete signature by using at least a threshold quantity of signature shares on which verification succeeds and by using a restoration function corresponding to private key shares generated by using the threshold signature algorithm.

As described above, in applications, the threshold signature algorithm can generate one total public key and n public-private key pairs, and can generate a restoration function corresponding to the n public-private key pairs. As described above, the restoration function can restore at least a threshold quantity of signatures verified to be correct to generate a complete signature. A threshold, that is, the threshold quantity, of the threshold signature algorithm can be set to w. Certainly, when there are more than w correct signatures, a complete signature can also be generated by using the restoration function. That is, when a quantity of correct signatures is greater than or equal to the threshold quantity w, a complete signature can be generated by using the restoration function, and the generated complete signature is deterministic, and does not change with the quantity of input correct signatures (provided that the quantity is greater than or equal to w).

Correctness of the generated complete signature can be verified by using the one total public key. In this way, any node that holds the total public key can verify the correctness of the complete signature by using the total public key. For example, after generating the complete signature, the node 1 can verify integrity of the complete signature by using the total public key. For example, a cryptographic operation is performed on the complete signature by using the total public key, to obtain a first hash, and a hash operation is performed on the original packet, to obtain a second hash. If the first hash is consistent with the second hash, the integrity of the complete signature can be determined. The integrity includes that the complete signature is specific to the original packet and the original packet is not tampered with. For another example, after generating the complete signature, the node 1 can send the complete signature, the total public key, and the original packet to a device outside the blockchain. The device can verify correctness of the complete signature by using the total public key and the original packet. A principle is the same as the above. Details are omitted for simplicity. The original packet here is still the above-mentioned content that includes the unique value of the original transaction list in the current consensus, or further includes the block number and/or the timestamp of the current block and/or the random seed generated in the previous block.

In addition, after collecting each commit message, each consensus node can verify a signature share in the received commit message by using a corresponding public key share, and then obtain a complete signature by using the at least threshold quantity of signature shares and by using the restoration function corresponding to the private key shares generated by using the threshold signature algorithm. Compared with the method in which the generated complete signature is verified by using the total public key, the method in which each signature share is verified by using the public key share and the complete signature is restored by using the restoration function after the verification succeeds can determine an incorrect signature and then can determine a possible malicious node.

In the threshold signature algorithm, each consensus node has the one total public key and one private key share and one corresponding public key share in the n public-private key pairs. As described above, the one total public key and the n public-private key pairs can be generated and distributed by the dealer, or can be obtained through negotiation between the consensus nodes.

Each consensus node can verify the signature share in the received commit message by using the corresponding public key share. Specifically, for example, in a consortium blockchain that includes four consensus nodes and that uses the PBFT consensus algorithm, a node 0 broadcasts a signature share σ_{3,0} generated by the node 0 to nodes 1, 2, and 3 in S110, where the subscript 3 in σ_{3,0} can represent a block number, and 0 can represent that this is a signature share of the node 0. In S120, the node 0 also receives signature shares a_{3,1} and σ_{3,2} respectively broadcast by the nodes 1 and 2. In this way, the node 0 has collected at least three signature shares, including the signature share a_{3,0} broadcast by the node 0 and the signature shares a_{3,1} and σ_{3,2} broadcast by the nodes 1 and 2. Certainly, the node 0 can also collect all signature shares a_{3,0}, σ_{3,1}, σ_{3,2}, and σ_{3,3}. In this way, the at least quorum quantity is certainly satisfied.

Further, the node 0 can verify correctness of collected σ_{3,0}, σ_{3,1}, and σ_{3,2}, or also σ₃₃ (or σ_{3,0}, σ_{3,1}, and σ_{3,3}, or also σ_{3,2}, or σ_{3,1}, σ_{3,2}, and σ_{3,3}, or also σ_{3,0}, or σ_{3,0}, σ_{3,2}, and σ_{3,3}, or also σ_{3,1}) by using a corresponding public key share. Specifically, for example, the node 0 can calculate the signature share σ_{3,1} by using the corresponding public key share, to obtain a hash value, denoted as hash_{3,1}; and the node 0 can further perform same hash calculation on the original packet, to obtain hash_{3,1}′. If hash_{3,1} is equal to hash_{3,1}′, it can be proved that the original packet is sent by the node 1, and is not tampered with in a transfer process. In this way, correctness of σ_{3,1} is verified. Similarly, the node 0 can verify σ^{3,2}, etc.

Similarly, the node 1 can verify correctness of collected σ_{3,0}, σ_{3,1}, and σ_{3,2}, or also σ_{3,3} (or σ_{3,0}, σ_{3,1}, and σ_{3,3}, or also σ_{3,2}, or σ_{3,1}, σ_{3,2}, and σ_{3,3}, or also σ_{3,0}, or σ_{3,0}, σ_{3,2}, and σ_{3,3}, or also σ_{3,1}) by using a corresponding public key share.

Similarly, the node 2 can verify correctness of collected σ_{3,0}, σ_{3,1}, and σ_{3,2}, or also σ_{3,3} (or σ_{3,0}, σ_{3,1}, and σ_{3,3}, or also σ_{3,2}, or σ_{3,1}, σ_{3,2}, and σ_{3,3}, or also σ_{3,0}, or σ_{3,0}, σ_{3,2}, and σ_{3,3}, or also σ_{3,1}) by using a corresponding public key share.

Similarly, the node 3 can verify correctness of collected σ_{3,0}, σ_{3,1}, and σ_{3,2}, or also σ_{3,3} (or σ_{3,0}, σ_{3,1}, and σ_{3,3}, or also σ_{3,2}, or σ_{3,1}, σ_{3,2}, and a_{3,3}, or also σ_{3,0}, or σ_{3,0}, σ_{3,2}, and σ_{3,3}, or also σ_{3,1}) by using a corresponding public key share.

S130: Each consensus node obtains a random seed based on the complete signature.

The random seed is an initial value used to generate a pseudorandom number in a pseudorandom number generator. For a pseudorandom number generator, the same random number sequence can be obtained starting from the same random seed. For a single computer, the random seed can be determined based on a state of the current computer, for example, a current time. For a distributed system, the same random seed needs to be generated on each node to generate the same random number based on the same random seed in a system contract/service contract/blockchain platform function, etc., and a random number should not be generated by any node in a controllable, predictable, or revocable way. This needs to be jointly determined by nodes participating in the consensus. In addition, considering that the distributed network is usually an asynchronous network or a partially synchronous network, from the perspective of immediacy, a random number can be generated and used when a transaction in the current block is executed.

After the above-mentioned steps S110 and S120 are performed, in a normal case, each consensus node can obtain the same complete signature. Certainly, considering a fault tolerance characteristic of the distributed system, at least a quorum quantity of consensus nodes should obtain the same complete signature in a blockchain network using the PBFT consensus algorithm.

In this way, based on the complete signature, each consensus node can generate a random seed by using the same random seed generation algorithm. A relatively simple random seed generation algorithm is, for example, a SHA-256 algorithm. Certainly, the complete signature can alternatively be directly used as a random seed.

After the above-mentioned process is performed, a random seed can be generated in the blockchain.

In this way, in a process in which the blockchain node outputs the consensus result after executing the current consensus, that is, in a process in which a series of transactions whose content and sequence are determined are executed, if a smart contract/system contract/blockchain platform code that needs to use the random number is included, execution can be performed based on the random seed in S130. For example, in a smart contract written in a C++ language, a mt19937(r) method provided by a C++ standard library or a boost library can be used to construct a cross-platform consistent random number engine, where the parameter r is a random seed. Similarly, both a random library in Python and a random library in Java provide similar random number generation methods. Based on the same random seed, the same random number can be generated in the same random number generation algorithm. In this way, for example, when each blockchain node executes the same transaction in the same block, for a process of generating the same random number, the same random number can be generated based on the same random seed, to complete service logic such as a lottery, a red packet, and a blind box, or complete a system contract/blockchain platform function, and obtain the same execution result on each node.

In addition, based on the above-mentioned solution, the following steps can be further included:

S140: Each consensus node places the obtained random seed into a block header of a generated current block.

In the structure shown in FIG. 6, in this application, a field “random seed”, that is, the random seed in S130, can be added to the block header. In this way, the random seed generated in the block can be recorded in the blockchain ledger. In addition, for replay of the block, transactions involving random numbers in the block can be replayed based on the random seed in the block header.

In the above-mentioned solution provided in this application, the threshold signature algorithm is combined with the PBFT consensus algorithm, so that after a consensus is reached on an original transaction list corresponding to each block by using the PBFT algorithm, a complete signature can be obtained by using the used threshold signature algorithm, to obtain a random seed. In a process of executing a transaction in the original transaction list corresponding to the block, a random number can be used. In this way, no additional waiting is needed to execute the transaction in the block.

In the above-mentioned solution provided in this application, based on the property of the threshold signature algorithm, each consensus node can restore the same complete signature by using a restoration function based on at least a threshold quantity of signature shares, to generate the same random seed. Therefore, when each blockchain node executes the same transaction in the same block, for a process of generating the same random number, the same random number can be generated based on the same random seed, to complete service logic such as a lottery, a red packet, and a blind box, or complete a system contract/blockchain platform function, and obtain the same execution result on each node.

In the above-mentioned solution provided in this application, the threshold signature algorithm is combined with the PBFT consensus algorithm, so that any consensus node cannot predict a complete signature before the consensus is completed, and even a primary node in PBFT cannot predict a complete signature, that is, cannot predict a random seed and a random number. In particular, when the threshold is equal to the quorum, once the consensus is completed, because the quorum quantity of nodes have reached an agreement on the content and sequence of the transaction list, that is, basic content for generating a new block is determined, complete signatures obtained by the at least quorum quantity of nodes based on the restoration function are the same, and random seeds generated by the quorum quantity of nodes are definitely the same. Even if there are no more than f nodes that act maliciously and want to control or revoke obtained random seeds, the f nodes do not affect system consistency, that is, the f nodes cannot control or revoke the generated complete signatures, random seeds, and random numbers.

The method in this application can be implemented in a process of generating each block. In this way, a block header of each block can include a random seed field. Even if a block body of a block does not include a transaction involving a random number, a process of generating the block can still include a process of generating a random seed.

As described above, the threshold signature algorithm can be an RSA-based threshold signature mechanism, an ECDSA-based threshold signature mechanism, a Schnorr-based threshold signature mechanism, a BLS-based threshold signature mechanism, etc. In the used threshold signature algorithm, one total public key and n public-private key pairs usually need to be generated. In typical and concise implementations, a quantity of private key shares can be equal to a quantity of consensus nodes, and each consensus node holds one private key, that is, one private key share. In this way, each consensus node signs the original packet based on the threshold signature algorithm by using the private key share of the consensus node, to generate a signature share. A minimum quantity, that is, a threshold quantity w, needed by the restoration function to generate a complete signature can be equal to the quorum in the PBFT algorithm, that is, a deterministic complete signature can be generated by using the corresponding restoration function based on at least w signature shares, regardless of which w shares are selected from n signature shares, provided that the at least w signatures are signatures added to the same original packet by using respective correct private key shares.

To implement the threshold signature algorithm on the consensus node in the blockchain, a mechanism needs to be used to enable each of the n consensus nodes to have one private key share and one corresponding public key share and have the same total public key. As described above, the one total public key and the n public-private key pairs can be generated by a centralized dealer and distributed to the n blockchain consensus nodes. This is a centralized key allocation method. In this centralized key allocation method, the third-party dealer needs to be used, which requires that the dealer does not act maliciously. For example, for implementation of the DKG protocol mentioned above, in principle, a polynomial of degree t needs to be generated, then n points are selected based on a curve formed by the polynomial, and n private key shares are generated by using the n points and are distributed to participants of n threshold signatures. If this process is performed on a dealer, and the dealer acts maliciously, the dealer can obtain the private key shares of all the n participants. This does not satisfy security needs of the blockchain system.

In addition, there is a decentralized key generation and allocation method. That is, the dealer is removed, the n consensus nodes obtain n public-private key pairs and one total public key through negotiation by using a key negotiation process, each consensus node still independently holds one of the n private key shares, and each consensus node holds the same total public key. This method is conventionally implemented outside a blockchain and depends on network synchronization. Nodes in the blockchain form a distributed network, and the distributed network is usually partially synchronous or asynchronous. Therefore, it is unreliable to implement key generation and allocation between nodes in the distributed network outside the blockchain. Implementing a reliable distributed key protocol is an important prerequisite for generating a random seed in the blockchain.

The above-mentioned PBFT protocol is a partial synchronous protocol, and is characterized by an assumption that the network is initially asynchronous but can become synchronous from a certain moment. To reach a consensus on the same proposal among different nodes in the network, a simplest way is to dispose a primary node, and the primary node unifies opinions of various nodes. A timer is disposed to prevent the primary node from making mistakes. In PBFT, if the normal case phase is not completed within a limited time, the backups are triggered to initiate the view change phase to change the primary node. In PBFT, the primary node is fixed at a position. All requests can be first sent to the primary node, and then broadcast by the primary node to other consensus nodes. In contrast, the HoneyBadger BFT (also usually briefly referred to as HBBFT) algorithm is an asynchronous protocol. The asynchronous protocol is applicable to asynchronous networks, that is, messages between nodes in the network can be arbitrarily delayed, but eventually arrive. The timer is removed from the HoneyBadger BFT, but execution of the protocol is driven by messages. In addition, all nodes in the HoneyBadger BFT algorithm are equal, and there is no distinction between the primary node and the backup node, that is, that is no primary change process. In an asynchronous network consensus protocol such as HBBFT, there is no concept of primary node, and each node can propose a request and attempt to construct a block. Therefore, the asynchronous network protocol alleviates a problem of fairness and a single node bottleneck to a certain extent.

For example, for Chinese patents ZL202111175184.1, ZL202111178795.1, ZL202111178745.3, ZL202111178754.2, ZL202111175144.7, and ZL202111175151.7, and Chinese Patent Application CN202111178779.2, a new consensus algorithm is proposed in consideration of a characteristic of a partially synchronous or asynchronous network of a blockchain network.

By using various consensus mechanisms in the blockchain network, overall consistency and synchronization of the blockchain network can be ensured. For the latter, block synchronization can be implemented provided that the blockchain can continuously generate blocks. Therefore, it is reliable to implement distributed key generation with reference to a blockchain.

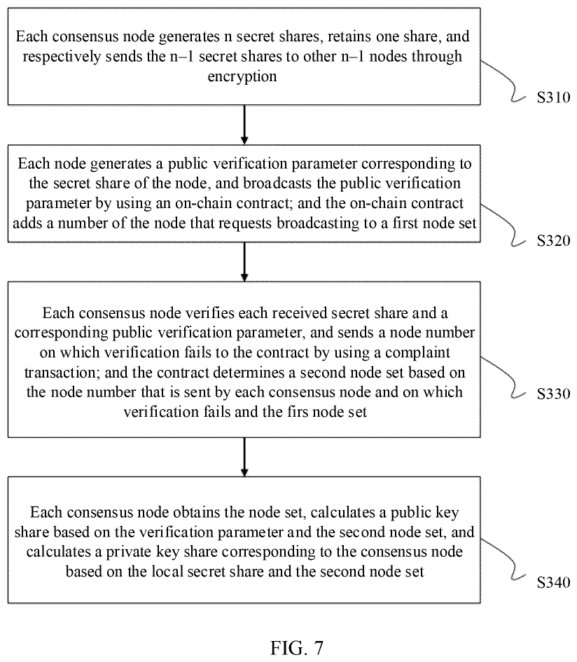

The following describes a method for implementing distributed key generation in a blockchain according to this application. As shown in FIG. 7, the method includes the following steps.

S310: Each consensus node generates a group of unique n secret shares, retains one share, and respectively sends the n−1 secret shares to other n−1 nodes through encryption.

Nodes are re-numbered in a DKG algorithm, starting from 1. Here, to be consistent with the DKG algorithm, the consensus nodes are also numbered starting from 1.

An elliptic curve cryptography (ECC) algorithm is a public key encryption technology, and is based on an elliptic curve theory. Encryption, decryption, and digital signatures are implemented by using an Abel group formed by points on an elliptic curve over a finite field and discrete logarithm intractability. The following uses an elliptic curve as an example for description. Each node can randomly select a polynomial of degree t from a group Z_{q}. A polynomial function of degree N is uniquely determined by N+1 points. Because a quorum quantity of consensus nodes in a blockchain network are finally needed to restore a signature, quorum=N+1. Therefore, a degree t of the polynomial is quorum−1. In this way, a complete signature can be obtained by restoring a quorum (quorum=t+1) of signature shares by a restoration function. Certainly, t can alternatively be set to another value. An elliptic curve constructed by using the polynomial can be expressed as follows:

$${f}_{i} ( z ) = {a}_{i 0} + {a}_{i 1} z + {a}_{i 2} {z}^{2} + … + {a}_{it} {z}^{t} \qquad Formula ( 1 )$$

In the formula (1), aᵢ₀, aᵢ₁, aᵢ₂, aᵢ₃, . . . , and aᵢₜ are coefficients of the polynomial, and a polynomial can be determined by using this group of coefficients.

When the quantity n of consensus nodes in the blockchain network is set to 4, and the quorum in an algorithm such as PBFT and HBBFT is 3, t=2. In this case, the polynomial is as follows:

$${f}_{i} ( z ) = {a}_{i 0} + {a}_{i 1} z + {a}_{i 2} {z}^{2} \qquad Formula ( 2 )$$

A node 1 can randomly select a group of numbers from a finite prime field as coefficients, that is, as a₁₀, a₁₁, and a₁₂. In this case, a generated polynomial is f₁(z)=a₁₀+a₁₁z+a₁₂z².

Similarly, a node 2 can randomly select a group of numbers from the same finite prime field as coefficients, that is, as a₂₀, a₂₁, and a₂₂. In this case, a generated polynomial is f₂(z)=a₂₀+a₂₁z+a₂₂z².

Similarly, a node 3 can randomly select a group of numbers from the same finite prime field as coefficients, that is, as a₃₀, a₃₁, and a₃₂. In this case, a generated polynomial is f₃(z)=a₃₀+a₃₁z+a₃₂z².

Similarly, a node 4 can randomly select a group of numbers from a finite prime field as coefficients, that is, as a₄₀, a₄₁, and a₄₂. In this case, a generated polynomial is f₄(z)=a₄₀+a₄₁z+a₄₂z².

Each node can further determine a group of secret shares based on the determined polynomial. The secret share can be determined based on the following formula by using the polynomial coefficient:

$${s}_{i j} = {f}_{i} ( j ) mod q ( j = 1 , … , n ) \qquad Formula ( 3 )$$

In the formula (3), q is the same large number used by each node, and an objective of performing a modulo operation on fᵢ(j) by using q is to limit a value of fᵢ(j) to a range of [0, q−1]. An example is as follows:

The consensus node 1 generates four secret shares: S₁₁=f₁(1) mod q, S₁₂=f₁(2) mod q, S₁₃=f₁(3) mod q, and S₁₄=f₁(4) mod q. Here, for the four secret shares, 4 is a total quantity of consensus nodes. That is, if a final objective is to generate a complete signature by a restoration function by selecting any w of n signature shares, n secret shares need to be generated here. The same applies below.

The consensus node 2 generates four secret shares: S₂₁=f₂(1) mod q, S₂₂=f₂(2) mod q, S₂₃=f₂(3) mod q, and S₂₄=f₂(4) mod q.

The consensus node 3 generates four secret shares: S₃₁=f₃(1) mod q, S₃₂=f₃(2) mod q, S₃₃=f₃(3) mod q, and S₃₄=f₃(4) mod q.

The consensus node 4 generates four secret shares: S₄₁=f₄(1) mod q, S₄₂=f₄(2) mod q, S₄₃=f₄(3) mod q, and S₄₄=f₄(4) mod q.

Further, in addition to retaining one secret share, each node can exchange another generated secret share with another consensus node by using a P2P network. Details can be as follows:

The consensus node 1 retains S₁₁, sends S₁₂ to the node 2, sends S₁₃ to the node 3, and sends S₁₄ to the node 4. Sending can be performed by using an underlying peer-to-peer (P2P) network component in the blockchain network. The sent secret share needs to be kept confidential. The consensus node 1 can respectively encrypt the to-be-sent secret shares by using public keys of receivers, and then send the secret shares to the receivers, or send the secret shares to the receivers by using a secure connection such as transport layer security (TLS).

The consensus node 2 retains S₂₂, sends S₂₁ to the node 1, sends S₂₃ to the node 3, and sends S₂₄ to the node 4. Sending can be performed by using an underlying P2P network component in the blockchain network. Similarly, the sent secret share needs to be kept confidential. The consensus node 2 can respectively encrypt the to-be-sent secret shares by using public keys of receivers, and then send the secret shares to the receivers, or send the secret shares to the receivers by using a secure connection such as TLS.

The consensus node 3 retains S₃₃, sends S₃₁ to the node 1, sends S₃₂ to the node 2, and sends S₃₄ to the node 4. Sending can be performed by using an underlying P2P network component in the blockchain network. Similarly, the sent secret share needs to be kept confidential. The consensus node 3 can respectively encrypt the to-be-sent secret shares by using public keys of receivers, and then send the secret shares to the receivers, or send the secret shares to the receivers by using a secure connection such as TLS.

The consensus node 4 retains S₄₄, sends S₄₁ to the node 1, sends S₄₂ to the node 2, and sends S₄₃ to the node 3. Sending can be performed by using an underlying P2P network component in the blockchain network. Similarly, the sent secret share needs to be kept confidential. The consensus node 4 can respectively encrypt the to-be-sent secret shares by using public keys of receivers, and then send the secret shares to the receivers, or send the secret shares to the receivers by using a secure connection such as TLS.

Two numbers in the subscript of the secret share can be seen. A number on a left side can represent a number of a node that sends the secret share, and a number on a right side can represent a node that receives the secret share. In this case, the consensus node 1 locally holds secret shares S₁₁, S₂₁, S₃₁, and S₄₁ generated by different nodes; the consensus node 2 locally holds secret shares S₁₂, S₂₂, S₃₂, and S₄₂ generated by different nodes; the consensus node 3 locally holds secret shares S₁₃, S₂₃, S₃₃, and S₄₃ generated by different nodes; and the consensus node 4 locally holds secret shares S₁₄, S₂₄, S₃₄, and S₄₄ generated by different nodes.

S₁₁ locally held by the consensus node 1 is generated by the consensus node 1, S₂₂ locally held by the consensus node 2 is generated by the consensus node 2, S₃₃ locally held by the consensus node 3 is generated by the consensus node 3, and S₄₄ locally held by the consensus node 4 is generated by the consensus node 4.

The consensus node preferably signs the to-be-sent secret share, for example, signs the secret share by using a private key of the consensus node, or uses a message authentication code (MAC), to ensure message integrity and avoid a man-in-the-middle attack. Correspondingly, a node that receives the secret share can verify correctness of the signature.

S320: Each node generates a public verification parameter corresponding to the secret share of the node, and broadcasts the public verification parameter by using an on-chain contract; and the on-chain contract adds a number of the node that requests broadcasting to a first node set.

Each consensus node can generate a group of verification parameters corresponding to the key share of the consensus node. A generation method can use the following formula:

$${A}_{i k} = {g}^{{a}_{i k}} ( k = 0 , \text{…} , t ) \qquad Formula ( 4 )$$

In the formula (4), g is a base point on the elliptic curve. Based on an operation property of the elliptic curve, the power of g is also a point on the elliptic curve. Here, t is the degree of the polynomial, and is usually set to (quorum−1). As described above, if a final objective is to generate a complete signature by a restoration function by selecting any w of n signature shares, the degree of the polynomial that needs to be set here is t, and t=w−1. The same applies below.

Based on the above-mentioned formula (4), if assume that t=2, a group of verification parameters generated by the consensus node 1 is <A₁₀, A₁₁, A₁₂>, and the group of verification parameters is broadcast by using the on-chain contract. Similarly, based on the above-mentioned formula, a group of verification parameters generated by the consensus node 2 is <A₂₀, A₂₁, A₂₂>, and the group of verification parameters is broadcast by using the on-chain contract. Similarly, based on the above-mentioned formula, a group of verification parameters generated by the consensus node 3 is <A₃₀, A₃₁, A₃₂>, and the group of verification parameters is broadcast by using the on-chain contract. Similarly, based on the above-mentioned formula, a group of verification parameters generated by the consensus node 4 is <A₄₀, A₄₁, A₄₂>, and the group of verification parameters is broadcast by using the on-chain contract.

Based on properties of cryptography, even if Aᵢₖ is published, aᵢₖ is not inferred. Therefore, even if published Aᵢₖ is obtained from the blockchain, the polynomial in S310 cannot be obtained.

Broadcasting is performed by using the on-chain contract. Specifically, each node can sign a transaction by using a private key of the node and send the transaction to the blockchain. A blockchain software development kit (SDK) can be embedded in each node. The SDK is a set of a series of program interfaces, documents, examples, development tools, etc. Through the embedded SDK, the blockchain node can initiate a transaction to the blockchain network like a blockchain client device. The transaction sent and signed by the blockchain node by using the private key of the blockchain node can include a call to a smart contract in the blockchain. The called contract is, for example, a DKG contract. The DKG contract can be a system-level contract, that is, a contract pre-deployed in the blockchain, for example, a contract created by an account with permission of a system administrator, serves as a system-level control function, and is not a contract independently developed and deployed by a user to implement specific service logic.

Like another contract, the DKG contract can be executed in a virtual machine (for example, an Ethereum virtual machine (EVM)), or certainly can be executed in a container (for example, a docker). Implementations are not limited here. When an external account initiates a transaction to the blockchain to call the on-chain contract, execution of the contract can be triggered. Content of the transaction includes, for example, a from field, a to field, a value field, and a data field. The from field can be an account address of a transaction initiator, the to field can represent an address of a to-be-called smart contract, the value field can be a native token (for example, a value of Ether in Ethereum) in the blockchain, and the data field can include a method and a parameter for calling the smart contract. By specifying the address of the to-be-called smart contract in the to field, a call to a certain smart contract in the blockchain can be indicated. The smart contract usually can include one or more functions, and each function can include some input parameters. In the transaction, a function in the to-be-called smart contract can be specified by using the data field, and the data field is filled with a parameter to be passed in.

A contract execution result can change storage of the contract, that is, a world state of the contract. In addition, the transaction execution result or related information can be recorded in a receipt in the blockchain. Specifically, the contract execution result/related information can be represented as an event in the receipt. A structure of the event is, for example, in the following format:

Event:
[topic][msg]
[topic][msg]
. . .

In the above-mentioned example, there can be one or more events. Each event can include fields such as a topic and data. A format of an event output during transaction execution can be specified in the contract. Through the embedded SDK, the blockchain client device or the blockchain node can listen for an event of a specific topic, obtain content of corresponding msg when the event of the specific topic is detected, and can perform predetermined processing after detecting the specific topic or certain content in corresponding msg.

In this event mechanism, the node can store an execution result in msg corresponding to a certain topic, so that a listener (that is, a client device or a blockchain node in which the blockchain SDK is embedded) that listens for the topic can obtain the corresponding execution result. In S320, a certain node can send the generated public verification parameter to the blockchain network by initiating a call to a first function (for example, a function named Broadcast, where the function can include a parameter, and the parameter can include the public verification parameter) in the DKG contract. A result of executing the transaction by the blockchain network is placing the public verification parameter in msg corresponding to a specific topic in the receipt. Therefore, the node that listens for the topic can obtain content in the msg field, that is, obtain the public verification parameter. In this way, broadcasting performed by using the on-chain contract is completed.

An event to be listened for can be registered with the blockchain node through the SDK. Specifically, the blockchain node can bind a hook function to the generated event in running blockchain platform code (the hook function can be edited together with the platform code in a development phase). The hook function is a callback function, can be called when the event to be listened for occurs, and can execute specific processing logic. Listening for code can include, for example, listening for one or more of transaction content of a blockchain transaction, a contract state of the smart contract, and a receipt generated in a contract. After the event to be listened for is registered with the blockchain node through the SDK, the blockchain node can store a mapping relationship between the event to be listened for and a listener (for example, a network connection of a client device/node that initiates event listening and in which the SDK is embedded, which usually can include information such as an IP address and a port number), for example, store a mapping relationship between a certain event of listening for a certain contract and a listener. When the hook function detects that a corresponding event topic occurs, the hook function can be called, and then the hook function can query the mapping relationship, and push the event that is listened for to the network connection. In this way, the SDK that initiates the listening can obtain the event that is listened for by using the maintained network connection. The execution of the contract is also broadcast by using the on-chain contract in a similar way. Specifically, the contract execution result and an execution result of another transaction in the block are stored in a transaction result cache of the blockchain node together. After all transactions in the blockchain are executed and organized into blocks, the blockchain platform code can listen for the receipt in the transaction result, and broadcast the event that is listened for to the SDK that initiates the listening. Here, in this monitoring mechanism, the node can listen for a registered specific topic event, and when such an event occurs, obtain msg corresponding to the topic by using a maintained connection, to obtain content in msg. The content in msg here includes a public verification parameter. In conclusion, the public verification parameter can be broadcast by using the event mechanism in the blockchain, and broadcast content can be received by using the event monitoring mechanism.

In this way, a result of broadcasting, by using the blockchain, the public verification parameter generated by each node can be as follows:

The consensus node 1 locally holds the secret shares S₁₁, S₂₁, S₃₁, and S₄₁ generated by different nodes and the verification parameters <A₁₀, A₁₁, A₁₂>, and can obtain the public verification parameters <A₂₀, A₂₁, A₂₂>, <A₃₀, A₃₁, A₃₂>, and <A₄₀, A₄₁, A₄₂> from the blockchain.

The consensus node 2 locally holds the secret shares S₁₂, S₂₂, S₃₂, and S₄₂ generated by different nodes and the verification parameters <A₂₀, A₂₁, A₂₂>, and can obtain the public verification parameters <A₁₀, A₁₁, A₁₂>, <A₃₀, A₃₁, A₃₂>, and <A₄₀, A₄₁, A₄₂> from the blockchain.

The consensus node 3 locally holds the secret shares S₁₃, S₂₃, S₃₃, and S₄₃ generated by different nodes and the verification parameters <A₃₀, A₃₁, A₃₂>, and can obtain the public verification parameters <A₁₀, A₁₁, A₁₂>, <A₂₀, A₂₁, A₂₂>, and <A₄₀, A₄₁, A₄₂> from the blockchain.

The consensus node 4 locally holds the secret shares S₁₄, S₂₄, S₃₄, and S₄₄ generated by different nodes and the verification parameters <A₄₀, A₄₁, A₄₂>, and can obtain the public verification parameters <A₁₀, A₁₁, A₁₂>, <A₂₀, A₂₁, A₂₂>, and <A₃₀, A₃₁, A₃₂> from the blockchain.

As described above, broadcasting is performed by using the on-chain contract. Specifically, each node can sign a transaction by using a private key of the node and send the transaction to the blockchain. For example, the public verification parameter generated by a certain node is sent to the blockchain network by initiating a transaction. For example, the transaction calls a function Broadcast(r) in the DKG contract. The function can include a parameter r, and r can include the public verification parameter. As described above, execution logic of the function Broadcast(r) includes placing the public verification parameter in msg corresponding to a specific topic in the receipt. In addition, the execution logic of the function Broadcast(r) can further include adding the number of the node that requests broadcasting to the first node set, that is, changing the storage of the contract, that is, changing the world state of the contract. If the consensus nodes 1 to 4 respectively send transactions for calling the function Broadcast(r) in the DKG contract, an execution result of the function Broadcast(r) includes storing numbers 1 to 4 of the four consensus nodes that initiate the transactions in a first state maintained by the contract. The state is, for example, in a form of {1, 2, 3, 4}, where { } represents a set, and the set is, for example, named Parties.

S330: Each consensus node verifies each received secret share and a corresponding public verification parameter, and sends a node number on which verification fails to the contract by using a complaint transaction; and the contract determines a second node set based on the node number that is sent by each consensus node and on which verification fails and the first node set.

Each consensus node can receive a secret share sent by any other node and receive a public verification parameter broadcast by the on-chain contract.

As described in S310, each consensus node generates n secret shares Sᵢⱼ, retains one share, and respectively sends the n−1 secret shares to the other n−1 nodes by using a P2P network component and through encryption. As described in S320, each node generates the public verification parameter corresponding to the secret share of the node, and broadcasts the public verification parameter by using the on-chain contract.

If a secret share sent by each node and a corresponding public verification parameters belong to the same polynomial, the following equation should be true:

$${g}^{{s}_{i j}} = {\prod }_{k = 0}^{t} {( {A}_{i k} )}^{{j}^{k}} ( i = 1 , … , n ) \qquad Formula ( 5 )$$

As described above, t=quorum−1. When n=4, quorum=3, and t=2.

Based on such a property in the formula (5), each received secret share and the public verification parameter can be verified by using the formula. If it is verified that the equation is true, it indicates that the secret share and the corresponding public verification parameter belong to the same polynomial. Otherwise, the secret share and the corresponding public verification parameter do not belong to the same polynomial. In this way, it can also be checked whether the node that generates the secret share and the corresponding public verification parameter has malicious behavior. For example, a typical malicious behavior is that the node generates Sᵢⱼ based on the first polynomial, but generates Aᵢₖ (k=0, . . . , and t) based on different polynomials.

Details of the verification can be as follows:

When j=1, the consensus node 1 can verify the following content:
i=1: g^{s}^{₁₁}=(A₁₀)¹^{⁰}·(A₁₁)¹^{¹}·(A₁₂)¹^{²} (actually, the consensus node 1 may not verify whether this equation is true because the secret share S₁₁ and the verification parameters <A₁₁, A₁₂, A₁₃> are generated by the consensus node 1);

$$i = 2 : {g}^{{s}_{21}} = {( {A}_{20} )}^{{1}^{0}} \cdot {( {A}_{21} )}^{{1}^{1}} \cdot {( {A}_{22} )}^{{1}^{2}} ;$$

$$i = 3 : {g}^{{s}_{31}} = {( {A}_{30} )}^{{1}^{0}} \cdot {( {A}_{31} )}^{{1}^{1}} \cdot {( {A}_{32} )}^{{1}^{2}} ; and$$

$$i = 4 : {g}^{{s}_{41}} = {( {A}_{40} )}^{{1}^{0}} \cdot {( {A}_{41} )}^{{1}^{1}} \cdot {( {A}_{42} )}^{{1}^{2}} .$$

If the equation corresponding to i=2 is not true, the consensus node 1 can send the node number 2 on which verification fails to the DKG contract. Similarly, if the equations corresponding to i=2 and 3 are not true, the consensus node 1 can send the node numbers 2 and 3 on which verification fails to the DKG contract. Similarly, if the equations corresponding to i=2, 3, and 4 are not true, the consensus node 1 can send the node numbers 2, 3, and 4 on which verification fails to the DKG contract.

When j=2, the consensus node 2 can verify the following content:
i=1: g^{s}^{₁₂}=(A¹⁰)²^{⁰}·(A₁₁)²^{¹}·(A₁₂)²^{²};
i=2: g^{s}^{₂₂}=(A₂₀)²^{⁰}·(A₂₁)²^{¹}·(A₂₂)²^{²} (actually, the consensus node 2 may not verify whether this equation is true because the secret share S₂₂ and the verification parameters <A₂₀, A₂₁, A₂₂> are generated by the consensus node 2);

$$i = 3 : {g}^{{s}_{32}} = {( {A}_{30} )}^{{2}^{0}} \cdot {( {A}_{31} )}^{{2}^{1}} \cdot {( {A}_{32} )}^{{2}^{2}} ; and$$

$$i = 4 : {g}^{{s}_{42}} = {( {A}_{40} )}^{{2}^{0}} \cdot {( {A}_{41} )}^{{2}^{1}} \cdot {( {A}_{42} )}^{{2}^{2}} .$$

If the equation corresponding to i=1 is not true, the consensus node 2 can send the node number 1 on which verification fails to the DKG contract. Similarly, if the equations corresponding to i=1 and 3 are not true, the consensus node 2 can send the node numbers 1 and 3 on which verification fails to the DKG contract. Similarly, if the equations corresponding to i=1, 3, and 4 are not true, the consensus node 2 can send the node numbers 1, 3, and 4 on which verification fails to the DKG contract.

When j=3, the consensus node 3 can verify the following content:
i=1: g^{s}^{₁₃}=(A₁₀)³^{⁰}·(A₁₁)³^{¹}·(A₁₂)³^{²};
i=2: g^{s}^{₂₃}=(A₂₀)³^{⁰}·(A₂₁)³^{¹}·(A₂₂)³^{²};
i=3: g^{s}^{₃₃}=(A₃₀)³^{⁰}·(A₃₁)³^{¹}·(A₃₂)³^{²} (actually, the consensus node 3 may not verify whether this equation is true because the secret share S₃₃ and the verification parameters <A₃₀, A₃₁, A₃₂> a re generated by the consensus node 3); and

$$i = 4 : {g}^{{s}_{43}} = {( {A}_{40} )}^{{3}^{0}} \cdot {( {A}_{41} )}^{{3}^{1}} \cdot {( {A}_{42} )}^{{3}^{2}} .$$

If the equation corresponding to i=1 is not true, the consensus node 3 can send the node number 1 on which verification fails to the DKG contract. Similarly, if the equations corresponding to i=1 and 2 are not true, the consensus node 3 can send the node numbers 1 and 2 on which verification fails to the DKG contract. Similarly, if the equations corresponding to i=1, 2, and 4 are not true, the consensus node 3 can send the node numbers 1, 2, and 4 on which verification fails to the DKG contract.

When j=4, the consensus node 4 can verify the following content:
i=1: g^{s}^{₁₄}=(A₁₀)⁴^{⁰}·(A₁₁)⁴^{¹}·(A₁₂)⁴^{²};
i=2: g^{s}^{₂₄}=(A₂₀)⁴^{⁰}·(A₂₁)⁴^{¹}·(A₂₂)⁴^{²};
i=3: g^{s}^{₃₄}=(A₃₀)⁴^{⁰}·(A₃₁)⁴^{¹}·(A₃₂)⁴^{²}; and
i=4: g^{s}^{₄₄}=(A₄₀)⁴^{⁰}·(A₄₁)⁴^{¹}·(A₄₂)⁴^{²} (actually, the consensus node 4 may not verify whether this equation is true because the secret share S₄₄ and the verification parameters <A₄₀, A₄₁, A₄₂> are generated by the consensus node 4).

If the equation corresponding to i=1 is not true, the consensus node 4 can send the node number 1 on which verification fails to the DKG contract. Similarly, if the equations corresponding to i=1 and 2 are not true, the consensus node 4 can send the node numbers 1 and 2 on which verification fails to the DKG contract. Similarly, if the equations corresponding to i=1, 2, and 3 are not true, the consensus node 4 can send the node numbers 1, 2, and 3 on which verification fails to the DKG contract.

Each node can sign a transaction by using a private key of the node and send the transaction to the blockchain. For example, a certain node sends a node number on which verification fails to the blockchain network by initiating a transaction. For example, if the transaction is a complaint transaction, the transaction can call a function Confirm(r) in the DKG contract. The function can include a parameter r, and r can include the node number that is submitted by the node, that is in the complaint transaction, and on which verification fails.

Execution logic of the function Confirm(r) can include copying a node number for which no complaint transaction is received in the first node set Parties into the second node set. Assume that the first node set Parties is {1, 2, 3, 4}, but the node number included in the complaint transaction received in the DKG contract is 4. For example, if the function Confirm(r) called in a complaint transaction initiated by the consensus node 1 includes a parameter r=4, the DKG contract marks the node number 4 in the first node set Parties as deleted. If no corresponding complaints are received for all other node numbers in the first node set Parties, the node numbers 1, 2, and 3 in the first node set are still retained. In this way, the DKG contract can determine the second node set {1, 2, 3} based on the node number 4 that is sent by each consensus node and on which verification fails and the first node set {1, 2, 3, 4}. The second node set is, for example, named QUAL.

It is worthwhile to note that in the blockchain network, because of a partial synchronous or asynchronous network characteristic, the contract is not necessarily executed in the same block, but a part may be executed in each of different blocks. In this case, a state machine usually can be set in the contract, to change a state of the state machine when a part is completed, or until the state machine changes to a final state. Each step performed by the state machine can be performed and triggered after a transaction is received. Therefore, in this step, determining of the node set by the DKG contract may span a plurality of blocks.

S340: Each consensus node calculates a public key share based on the verification parameter and the second node set, and calculates a private key share corresponding to the consensus node based on the local secret share and the second node set.

In one aspect, each consensus node can locally calculate the public key share based on the verification parameter and the second node set, and can calculate the public key share based on the following formula:

$$p u {b}_{j} = {\prod }_{i ∈ Q U A L} {\prod }_{k = 0}^{t} {( {A}_{i k} )}^{{j}^{k}} \qquad Formula ( 6 )$$

In another aspect, each consensus node can calculate the private key share corresponding to the consensus node based on the local secret share, the second node set, and the following formula:

$${x}_{j} = {\sum }_{i ∈ QUAL} {s}_{ij} mod q \qquad Formula ( 7 )$$

For example, the consensus node 1 locally calculates a private key share of the consensus node 1 as follows:

$${x}_{1} = {\sum }_{i ∈ QUAL} {s}_{i 1} mod q = ( {s}_{11} + {s}_{21} + {s}_{31} + {s}_{41} ) mod q$$

The consensus node 2 locally calculates a private key share of the consensus node 2 as follows:

$${x}_{2} = {\sum }_{i ∈ QUAL} {s}_{i 2} mod q = ( {s}_{12} + {s}_{22} + {s}_{32} + {s}_{42} ) mod q$$

The consensus node 3 locally calculates a private key share of the consensus node 3 as follows:

$${x}_{3} = {\sum }_{i ∈ QUAL} {s}_{i 3} mod q = ( {s}_{13} + {s}_{23} + {s}_{33} + {s}_{43} ) mod q$$

The consensus node 4 locally calculates a private key share of the consensus node 4 as follows:

$${x}_{4} = {\sum }_{i ∈ QUAL} {s}_{i 4} mod q = ( {s}_{14} + {s}_{24} + {s}_{34} + {s}_{44} ) mod q$$

It can be seen that the private key shares calculated by the node 1, the node 2, the node 3, and the node 4 are different.

In still another aspect, each consensus node can locally calculate a total public key based on the verification parameter and the second node set, and can calculate the total public key based on the following formula:

$$y = {\prod }_{i ∈ QUAL} {y}_{i} \qquad Formula ( 7 )$$

Here, yᵢ=Aᵢ₀.

In this way, for example, the consensus node 1 can calculate a total public key as follows:

$$y = {y}_{1} * {y}_{2} * {y}_{3} * {y}_{4} = {A}_{10} * {A}_{20} * {A}_{30} * {A}_{40}$$

Similarly, for example, the consensus node 2 can calculate a total public key as follows:

$$y = {y}_{1} * {y}_{2} * {y}_{3} * {y}_{4} = {A}_{10} * {A}_{20} * {A}_{30} * {A}_{40}$$

Similarly, for example, the consensus node 3 can calculate a total public key as follows:

$$y = {y}_{1} * {y}_{2} * {y}_{3} * {y}_{4} = {A}_{10} * {A}_{20} * {A}_{30} * {A}_{40}$$

Similarly, for example, the consensus node 4 can calculate a total public key as follows:

$$y = {y}_{1} * {y}_{2} * {y}_{3} * {y}_{4} = {A}_{10} * {A}_{20} * {A}_{30} * {A}_{40}$$

It can be seen that the total public keys calculated by the node 1, the node 2, the node 3, and the node 4 are the same, that is, according to the above-mentioned method, each node obtains the same total public key.

The private key share x₁ corresponds to the public key share pub₁, the private key share x₂ corresponds to the public key share pub₂, the private key share x₃ corresponds to the public key share pub₃, and the private key share x₄ corresponds to the public key share pub₄. As described above, a signature share added by using a corresponding private key share can be verified by using each public key share. In addition, a complete signature restored by the restoration function from signature shares generated by using at least a quorum quantity of private key shares can be verified by the corresponding one total public key.

For another example, if the second node set is {1, 2, 3}, the public key share calculated by the consensus node 1 can be as follows:

$${pub}_{1} = {\prod }_{i ∈ QUAL} {\prod }_{k = 0}^{t} {( {A}_{i k} )}^{{1}^{k}} = {( {A}_{10} )}^{{1}^{0}} * {( {A}_{11} )}^{{1}^{1}} * {( {A}_{12} )}^{{1}^{2}} * {( {A}_{20} )}^{{1}^{0}} * {( {A}_{21} )}^{{1}^{1}} * {( {A}_{22} )}^{{1}^{2}} * {( {A}_{30} )}^{{1}^{0}} * {( {A}_{31} )}^{{1}^{1}} * {( {A}_{32} )}^{{1}^{2}}$$

Similarly, for example, the public key share calculated by the consensus node 2 can be as follows:

$${pub}_{2} = {\prod }_{i ∈ QUAL} {\prod }_{k = 0}^{t} {( {A}_{i k} )}^{{2}^{k}} = {( {A}_{10} )}^{{2}^{0}} * {( {A}_{11} )}^{{2}^{1}} * {( {A}_{12} )}^{{2}^{2}} * {( {A}_{20} )}^{{2}^{0}} * {( {A}_{21} )}^{{2}^{1}} * {( {A}_{22} )}^{{2}^{2}} * {( {A}_{30} )}^{{2}^{0}} * {( {A}_{31} )}^{{2}^{1}} * {( {A}_{32} )}^{{2}^{2}}$$

Similarly, for example, the public key share calculated by the consensus node 3 can be as follows:

$${pub}_{3} = {\prod }_{i ∈ QUAL} {\prod }_{k = 0}^{t} {( {A}_{i k} )}^{{3}^{k}} = {( {A}_{10} )}^{{3}^{0}} * {( {A}_{11} )}^{{3}^{1}} * {( {A}_{12} )}^{{3}^{2}} * {( {A}_{20} )}^{{3}^{0}} * {( {A}_{21} )}^{{3}^{1}} * {( {A}_{22} )}^{{3}^{2}} * {( {A}_{30} )}^{{3}^{0}} * {( {A}_{31} )}^{{3}^{1}} * {( {A}_{32} )}^{{3}^{2}}$$

It can be seen that if the node 4 acts maliciously, the secret share of the node 4 and the corresponding public verification parameter are not generated based on the same polynomial, and verification by at least one node fails and a complaint is initiated, the second node set does not include the node 4. In a process of calculating the public key shares by at least the node 1, the node 2, and the node 3, the public verification parameter generated by the node 4 is not used as a basis, but the public verification parameters generated by the node 1, the node 2, and the node 3 in the second node set are used as a basis.

Each consensus node can calculate the private key share corresponding to the consensus node based on the local secret share and the second node set.

For example, the consensus node 1 locally calculates a private key share of the consensus node 1 as follows:

$${x}_{1} = {\sum }_{i ∈ QUAL} {s}_{i 1} mod q = ( {s}_{11} + {s}_{21} + {s}_{31} ) mod q$$

The consensus node 2 locally calculates a private key share of the consensus node 2 as follows:

$${x}_{2} = {\sum }_{i ∈ QUAL} {s}_{i 2} mod q = ( {s}_{12} + {s}_{22} + {s}_{32} ) mod q$$

The consensus node 3 locally calculates a private key share of the consensus node 3 as follows:

$${x}_{3} = {\sum }_{i ∈ QUAL} {s}_{i 3} mod q = ( {s}_{13} + {s}_{23} + {s}_{33} ) mod q$$

The consensus node 4 locally calculates a private key share of the consensus node 4 as follows:

$${x}_{4} = {\sum }_{i ∈ QUAL} {s}_{i 4} mod q = ( {s}_{14} + {s}_{24} + {s}_{34} ) mod q$$

It can be seen that if the node 4 acts maliciously, the secret share of the node 4 and the corresponding public verification parameter are not generated based on the same polynomial, and verification by at least one node fails and a complaint is initiated, the second node set does not include the node 4. In a process of calculating the private key shares by at least the node 1, the node 2, and the node 3, the secret share generated by the node 4 is not used as a basis, but the secret shares generated by the node 1, the node 2, and the node 3 in the second node set are used as a basis. In addition, the private key shares calculated by at least the node 1, the node 2, and the node 3 are different.

Each consensus node can locally calculate the total public key based on the verification parameter and the second node set.

In this way, for example, the consensus node 1 can calculate a total public key as follows:

$$y = {y}_{{1}^{*}} {y}_{{2}^{*}} {y}_{3} = {A}_{1 {0}^{*}} {A}_{2 {0}^{*}} {A}_{30}$$

Similarly, for example, the consensus node 2 can calculate a total public key as follows:

$$y = {y}_{1} * {y}_{2} * {y}_{3} = {A}_{10} * {A}_{20} * {A}_{30}$$

Similarly, for example, the consensus node 3 can calculate a total public key as follows:

$$y = {y}_{1} * {y}_{2} * {y}_{3} = {A}_{10} * {A}_{20} * {A}_{30}$$

Similarly, for example, the consensus node 4 can calculate a total public key as follows:

$$y = {y}_{1} * {y}_{2} * {y}_{3} = {A}_{10} * {A}_{20} * {A}_{30}$$

It can be seen that if the node 4 acts maliciously, the secret share of the node 4 and the corresponding public verification parameter are not generated based on the same polynomial, and verification by at least one node fails and a complaint is initiated, the second node set does not include the node 4. In a process of calculating the total public keys by at least the node 1, the node 2, and the node 3, the public verification parameter generated by the node 4 is not used as a basis, but the public verification parameters generated by the node 1, the node 2, and the node 3 in the second node set are used as a basis. In addition, the total public keys calculated by at least the node 1, the node 2, and the node 3 are the same, that is, according to the above-mentioned method, at least an honest node obtains the same total public key.

Therefore, for a total of n consensus nodes, a threshold signature algorithm is used, and it is expected that at least any w signature shares in m signature shares can be restored to obtain a complete signature. If there is no malicious node, that is, the secret share and the corresponding public verification parameter are generated based on the same polynomial, n can be equal to m. If there is a malicious node, for example, there are b malicious nodes, m=n−b, and w remains unchanged, but it needs to be ensured that m is not less than w. Otherwise, the threshold signature algorithm is invalid.

As described in S330, each consensus node verifies each received secret share and the corresponding public verification parameter. If verification fails, the verification node can sign a complaint transaction by using the private key of the verification node, and send the complaint transaction to the blockchain. Specifically, the transaction can call a function Confirm(r) in the DKG contract. The function can include a parameter r, and r can include the node number that is submitted by the node, that is in the complaint transaction, and on which verification fails. For example, a node j receives a secret share Sᵢⱼ sent by a node i through encryption in S310, and the receiving node j verifies, by using the formula (5), the Sᵢⱼ sent by i. A typical verification failure case is that Sᵢⱼ sent by the node i does not correspond to a public verification parameter generated by the node i and broadcast by using the on-chain contract. Therefore, the node j that receives the secret share Sᵢⱼ can perform verification in S330, and can send a number i of the node to the DKG contract after verification fails. To prove that the secret share sent by the node i is not tampered with, in addition to the number i of the node, the node j can send a secret share and a signature of the node i to the DKG contract together. As described in S310, the node can signal the generated and sent secret share. To enable the DKG contract to verify the secret share and the corresponding public verification parameter, a plaintext, that is, a plaintext obtained after the node j decrypts the secret share encrypted by the node i, of the secret share needs to be included in the complaint transaction. In addition, to enable the DKG contract to verify a signature, it is preferable that the secret share is first signed by the node i in S310, and the plaintext secret share and the signature are encrypted together and then sent to the node j, that is, the consensus node that generates the secret share signs the generated secret share and encrypts and sends the secret share to another node. In this way, in addition to the number of the node i, a complaint transaction sent by the node j to the DKG contract includes the plaintext secret share sent by the node i to the node j and the signature of the generator i for the generated plaintext secret share.

Before the DKG contract determines the second node set based on the node number that is sent by each consensus node and on which verification fails and the first node set, the DKG contract can first verify the signature of the secret share in the complaint transaction; and if the verification is correct, can determine that the secret share originally sent by the node i to the node j in the above-mentioned example is not tampered with. Further, the DKG contract can verify whether the secret share and the corresponding public verification parameter belong to the same polynomial, for example, perform verification based on the formula (5). If it is verified, based on the formula (5), that the equation is not true, it can be determined that the secret share and the corresponding public verification parameter do not belong to the same polynomial, and the complaint is true. If it is verified, based on the formula (5), that the equation is true, it can be determined that the secret share and the corresponding public verification parameter belong to the same polynomial, and the complaint is not true. In a case that the complaint is true, that is, verification failure is determined, the DKG contract can determine the second node set based on the node number in the complaint transaction and the first node set. For example, if the complaint transaction includes the node number 4, as described in the above-mentioned example, the DKG contract can mark the node number 4 in the first node set Parties as deleted, and the first node set is Parties={1, 2, 3, 4}. Further, the DKG contract can determine the second node set QUAL={1, 2, 3} based on the node number 4 on which verification fails and the Parties set {1, 2, 3, 4}. In a case that the complaint is not true, that is, verification failure cannot be determined, the DKG contract does not mark the node number 4 in the first node set Parties as deleted, and therefore does not set QUAL to {1, 2, 3}, but still maintains {1, 2, 3, 4}.

In addition, it is possible that in a current distributed key generation process, a secret share sent by the node i to the node j is not consistent with a corresponding public verification parameter generated by the node i, and therefore a complaint transaction of the node j for the node i succeeds, while in a next distributed key generation process, a secret share sent by the node i to the node j is actually consistent with a corresponding public verification parameter generated by the node i. In this case, in the next round, the node j can still initiate a complaint transaction by using a plaintext secret share and a signature of the node i in the current round, resulting in incorrect determining of the DKG contract in the next round. This is clearly a malicious complaint. Therefore, in a distributed key generation process of each round, a sequence number that represents the distributed key generation process of the current round can be included in an initiated transaction, for example, epoch. Each time a new round of distributed key generation is performed, epoch can be increased by 1 based on an original value. In this way, in S310, the secret share generated and sent by the node i and epoch can be signed together and then encrypted. Further, in a distributed key generation process of epoch=p, if the node i acts maliciously, the node j can send, by using a complaint transaction, the number of the node i on which verification fails and the secret share, epoch=p, and the signature that are sent by the node i to the node j, so that after receiving the complaint transaction, the DKG contract can perform verification, and can first verify, by using the signature, that the plaintext secret share in the original packet and epoch=p are not tampered with. In this way, in a distributed key generation process of epoch=p+1, if the node i does not act maliciously, even if the node j sends, by using a complaint transaction, the number of the node i on which verification fails and the plaintext secret share, epoch=p+1, and the signature of the previous round that are sent by the node i to the node j, because the signature of the previous round is specific to epoch=p, the signature cannot match the original packet. Therefore, after receiving the complaint transaction, the DKG contract can first verify, by using the signature, that the original packet is tampered with and does not trust the current complaint, thereby avoiding a malicious complaint.

It is worthwhile to note that the plaintext secret share sent in S330 occurs under a premise that an honest node inevitably responds correctly within a specific time. In this way, a case in which a private key share is disclosed because all secret shares are sent is avoided, and a final complete signature is not disclosed.

In S320, the public verification parameter broadcast by each consensus node by using the on-chain contract is further accompanied by the round. In this way, the round to which the public verification parameter belongs can be distinguished when there is a delay in the network.

According to the above-mentioned method, while overall consistency and synchronization of the blockchain network is ensured by using the consensus mechanism, distributed key generation is implemented with reference to the blockchain smart contract, to ensure that a distributed key is generated through collaboration between participants and a consistent and reliable result is generated. Therefore, original strong dependence on network synchronization for implementing distributed key generation outside a blockchain is avoided, and a problem of unreliability of a generated result in this case is resolved.

In FIG. 7 and the corresponding embodiments, there is a relatively large quantity of messages. For example, in S310, each consensus node generates a group of unique n secret shares, and respectively sends the n−1 secret shares to the other n−1 nodes through encryption. The encrypted sending is usually performed outside the blockchain in a peer-to-peer (P2P) way. Therefore, for a blockchain network including n consensus nodes, message complexity is n². For example, for 100 consensus nodes, a message size is an order of magnitude of 10000. It can be seen that in this mode, a relatively large quantity of messages are sent, and relatively high bandwidth is occupied, which greatly affects performance of the blockchain.

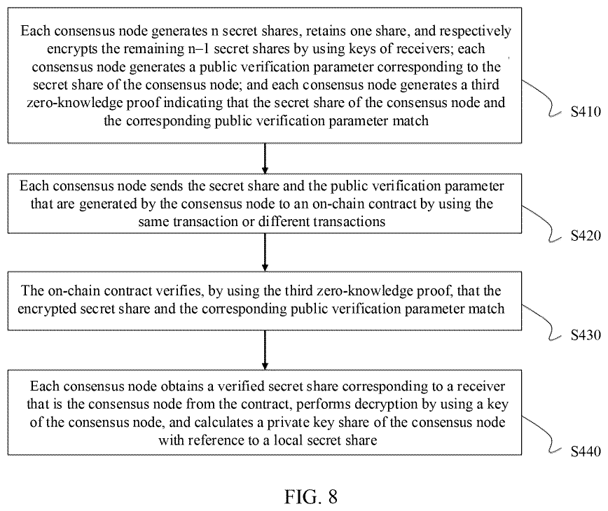

This application provides a method for implementing distributed key generation in a blockchain. As shown in FIG. 8, the method includes the following steps.

S410: Each consensus node generates n secret shares, retains one share, and respectively encrypts the remaining n−1 secret shares by using keys of receivers; each consensus node generates a public verification parameter corresponding to the secret share of the consensus node; and each consensus node generates a third zero-knowledge proof indicating that the secret share of the consensus node and the corresponding public verification parameter match.

An elliptic curve is still used as an example for description. Assume that a quantity of consensus nodes in a blockchain network is n, and a threshold w in a threshold signature is equal to a quorum in a used consensus algorithm, that is, w=quorum. Each node can randomly select a polynomial of degree t from a group Z_{q}. In this way, based on the above-mentioned formula, t=w−1=quorum−1. Certainly, w can alternatively be another value. In this case, t=w−1 is still maintained. The following uses w=quorum as an example for description.

Each node can randomly select a polynomial of degree t from the group Z_{q}. An example is as follows:

$${f}_{i} ( z ) = {a}_{i 0} + {a}_{i 1} z + {a}_{i 2} {z}^{2} + … + {a}_{it} {z}^{t} \qquad Formula ( 1 )$$

In the formula (1), aᵢ₀, aᵢ₁, aᵢ₂, aᵢ₃, . . . , and aᵢₜ are coefficients of the polynomial, and a polynomial can be determined by using this group of coefficients.

When the quantity n of consensus nodes in the blockchain network is set to 4, and the quorum in an algorithm such as PBFT and HBBFT is 3, t=2. In this case, the polynomial is as follows:

$${f}_{i} ( z ) = {a}_{i 0} + {a}_{i 1} z + {a}_{i 2} {z}^{2} \qquad Formula ( 2 )$$

A node 1 can randomly select a group of numbers from a finite prime field as coefficients, that is, as a₁₀, a₁₁, and a₁₂. In this case, a generated polynomial is f₁(z)=a₁₀+a₁₁z+a₁₂z², where a₁₀ is a secret s₁ set by the node 1.

Similarly, a node 2 can randomly select a group of numbers from the same finite prime field as coefficients, that is, as a₂₀, a₂₁, and a₂₂. In this case, a generated polynomial is f₂(z)=a₂₀+a₂₁z+a₂₂z², where a₂₀ is a secret s₂ set by the node 2.

Similarly, a node 3 can randomly select a group of numbers from the same finite prime field as coefficients, that is, as a₃₀, a₃₁, and a₃₂. In this case, a generated polynomial is f₃(z)=a₃₀+a₃₁z+a₃₂z², where a₃₀ is a secret s₃ set by the node 3.

Similarly, a node 4 can randomly select a group of numbers from the same finite prime field as coefficients, that is, as a₄₀, a₄₁, and a₄₂. In this case, a generated polynomial is f₄(z)=a₄₀+a₄₁z+a₄₂z², where a₄₀ is a secret s₄ set by the node 4.

Each node can further determine a group of secret shares based on the determined polynomial. The secret share can be determined based on the following formula by using the polynomial coefficient:

$${s}_{i j} = {f}_{i} ( j ) mod q ( j = 1 , … , n ) \qquad Formula ( 3 )$$

In the formula (3), q is the same large number used by each node, and is also referred to as an order, and an objective of performing a modulo operation on fᵢ(j) by using q is to limit a value of fᵢ(j) to a range of [0, q−1]. An example is as follows:

The node 1 generates four secret shares: S₁₁=f₁(1) mod q, S₁₂=f₁(2) mod q, S₁₃=f₁(3) mod q, and S₁₄=f₁(4) mod q.

The node 2 generates four secret shares: S₂₁=f₂(1) mod q, S₂₂=f₂(2) mod q, S₂₃=f₂(3) mod q, and S₂₄=f₂(4) mod q.

The node 3 generates four secret shares: S₃₁=f₃(1) mod q, S₃₂=f₃(2) mod q, S₃₃=f₃(3) mod q, and S₃₄=f₃(4) mod q.

The node 4 generates four secret shares: S₄₁=f₄(1) mod q, S₄₂=f₄(2) mod q, S₄₃=f₄(3) mod q, and S₄₄=f₄(4) mod q.

Each consensus node retains one of the generated n secret shares, and can respectively encrypt the remaining n−1 secret shares by using the keys of the receivers. An asymmetric encryption method is preferred here. Asymmetric encryption is a public key encryption scheme. A secret receiver generates a public-private key pair, publishes a public key, and keeps a private key confidential. After a secret sender performs encryption by using the published public key, only a receiver holding the corresponding private key can perform decryption, and a person who does not hold the corresponding private key cannot perform decryption. Although symmetric encryption can also implement encrypted transmission, keys cannot be disclosed, and both encryption and decryption parties need to hold the same key. In this way, problems such as key negotiation and key transmission needed for symmetric encryption, and man-in-the-middle attacks can be avoided.

An example is as follows:

For the four secret shares s₁₁, s₁₂, s₁₃, s₁₄ generated by the node 1, the node 1 retains s₁₁, encrypts s₁₂ by using a public key pk₂ of the node 2, encrypts s₁₃ by using a public key pk₃ of the node 3, and encrypts s₁₄ by using a public key pk₄ of the node 4.

For the four secret shares s₂₁, s₂₂, s₂₃, s₂₄ generated by the node 2, the node 2 retains s₂₂, encrypts s₂₁ by using a public key pk₁ of the node 1, encrypts s₂₃ by using the public key pk₃ of the node 3, and encrypts s₂₄ by using the public key pk₄ of the node 4.

For the four secret shares s₃₁, s₃₂, s₃₃, S₃₄ generated by the node 3, the node 3 retains s₃₃, encrypts s₃₁ by using the public key pk₁ of the node 1, encrypts s₃₂ by using the public key pk₂ of the node 2, and encrypts s₃₄ by using the public key pk₄ of the node 4.

For the four secret shares s₄₁, s₄₂, s₄₃, S₄₄ generated by the node 4, the node 4 retains s₄₄, encrypts s₄₁ by using the public key pk₁ of the node 1, encrypts s₄₂ by using the public key pk₂ of the node 2, and encrypts s₄₃ by using the public key pk₃ of the node 3.

Correspondingly, each consensus node can generate a public verification parameter Aᵢₖ, k=1, 2, . . . , t corresponding to the polynomial of the consensus node. As described above, Aᵢₖ=g^{a}^{ᵢₖ}. Because multiplication of the group of public verification parameters can be used to verify a point on a curve corresponding to the polynomial, and the generated public verification parameter is in the same form as the public key generated on ECC, that is, pubᵢ=Πₖ₌₀^{t}Aᵢₖ^{x}^{ᵢ}^{^{k}}, a result of the multiplication is also referred to as a public key. For xᵢ=i, pkᵢ=Πₖ₌₀^{t}Aᵢₖⁱ^{^{k}}.

When the total quantity of nodes is n=4 and the threshold w=3, that is, a degree of the polynomial is t=2, a public key of the node 1 is pub₁=A₁₀¹^{⁰}·A₁₁¹^{¹}·A₁₂¹^{²}=g^{a}^{₁₀}^{·1}^{⁰}·g^{a}^{₁₁}^{·1}^{¹}, g^{a}^{₁₂}^{·1}^{²}; a public key of the node 2 is pub₂=A₂₀²^{⁰}·A₂₁²^{¹}·A₂₂²^{²}=g^{a}^{₂₀}^{·2}^{⁰}·g^{a}^{₂₁}^{·2}^{¹}·g^{a}^{₂₂}^{·2}^{²}; a public key of the node 3 is pub₃=A₃₀³^{⁰}·A₃₁³^{¹}·A₃₂³^{²}=g^{a}^{₃₀}^{·3}^{⁰}·g^{a}^{₃₁}^{·3}^{¹}·g^{a}^{₃₂}^{·3}^{²}; and a public key of the node 4 is pub₄=A₄₀⁴^{⁰}·A₄₁⁴^{¹}·A₄₂⁴^{²}=g^{a}^{₄₀}^{·4}^{⁰}·g^{a}^{₄₁}^{·4}^{¹}·g^{a}^{₄₂}^{·4}^{²}.

Here, pkⱼ represents a public key of a node j. The public key pkⱼ is different from the public key pubᵢ. The public key pkⱼ represents a public key in a public-private key pair generated by each node, and can be referred to as a first public key here. The public key pubᵢ represents a public key related to the polynomial generated by the node, and can be referred to as a second public key.

In addition, each consensus node further generates the third zero-knowledge proof indicating that the secret share of the consensus node and the corresponding public verification parameter match. In S420, the encrypted secret share needs to be sent to an on-chain contract by using a transaction, and the encrypted secret share cannot be exposed. Therefore, the above-mentioned formula (5) cannot be directly used to verify that the secret share and the public verification parameter match. Alternatively, each consensus node can generate, by using a Sigma protocol, the third zero-knowledge proof indicating that the secret share encrypted by the consensus node and the corresponding public verification parameter match. Correspondingly, whether the encrypted secret share and the corresponding public verification parameter match can be verified by using the third zero-knowledge proof and the Sigma protocol.

S420: Each consensus node can send the secret share, the public verification parameter, and the third zero-knowledge proof indicating that the secret share and the corresponding public verification parameter match that are generated by the consensus node to an on-chain contract by using the same transaction or different transactions.

A transaction sent and signed by a blockchain node by using a private key of the blockchain node can include a call to a smart contract in a blockchain. A contract can be pre-deployed in the blockchain, for example, a DKG contract here. The deployed contract can have an on-chain contract address. Subsequently, the on-chain contract can be called by initiating a transaction, for example, a receiver address of the transaction is set to an address of a contract that needs to be called.

The consensus node can sign a transaction by using a private key of the consensus node and send the transaction to the blockchain. The receiver address of the transaction can be set to an address of the DKG contract. In addition, the transaction can carry a parameter input for calling the contract, and can indicate a function in the to-be-called contract. The input parameter and the function that indicates the call can be located in a data field of the transaction.

In an implementation, each consensus node can send the secret share, the public verification parameter, and the third zero-knowledge proof indicating that the secret share and the corresponding public verification parameter match that are generated by the consensus node to the on-chain contract by sending one transaction.

In another implementation, each consensus node can send the secret share generated and encrypted by the consensus node to the on-chain contract by sending a first transaction. The encrypted secret share can be set in a data field of the first transaction. Similarly, each consensus node can send the public verification parameter generated by the consensus node to the on-chain contract by sending a second transaction. Similarly, each consensus node can send the third zero-knowledge proof indicating that the secret share and the corresponding public verification parameter match and generated by the consensus node to the on-chain contract by sending a third transaction. The first, second, and third transactions are, for example, transactions for calling the DKG contract. Alternatively, the secret share and the public verification parameter are sent to the on-chain contract by using the same transaction, and the third zero-knowledge proof is sent to the on-chain contract by using another transaction. Alternatively, the third zero-knowledge proof and the public verification parameter are sent to the on-chain contract by using the same transaction, and the secret share is sent to the on-chain contract by using another transaction. Alternatively, the secret share and the third zero-knowledge proof are sent to the on-chain contract by using the same transaction, and the public verification parameter is sent to the on-chain contract by using another transaction.

S430: The on-chain contract verifies, by using the third zero-knowledge proof, that the encrypted secret share and the corresponding public verification parameter match.

After receiving the third zero-knowledge proof, the secret share, and the corresponding public verification parameter by using a transaction, the on-chain contract can verify, by using the third zero-knowledge proof, that the encrypted secret share and the corresponding public verification parameter match, as described above.

After the verification succeeds, the on-chain contract has the public verification parameter corresponding to the polynomial generated by each consensus node. Therefore, the on-chain contract can generate a total public key based on the public verification parameter. This is similar to the above-mentioned formula (7).

S440: Each consensus node obtains a verified secret share corresponding to a receiver that is the consensus node from the contract, performs decryption by using a key of the consensus node, and calculates a private key share of the consensus node with reference to a local secret share.

This is similar to S340. Details are omitted for simplicity.

The on-chain contract generates the total public key in S430. Therefore, in step S440 or a subsequent step, each consensus node can further obtain the total public key from the contract information. Certainly, each consensus node can alternatively obtain the public verification parameter from the contract information, and calculate the total public key based on the obtained public verification parameter.

In the above-mentioned embodiments, for n nodes, a secret share generated by each node is encrypted and then sent to the on-chain contract, and message complexity is n. Therefore, peer-to-peer encrypted transmission between nodes is avoided, that is, message complexity of n² is avoided. It can be seen that a quantity of messages can be greatly reduced.

In addition, by sending the secret share, the public verification parameter, and the third zero-knowledge proof that are generated by each node to the on-chain contract, whether the secret share and the corresponding public verification parameter match can be verified by code logic in the on-chain contract by using the third zero-knowledge proof. Therefore, a case in which the node independently performs off-chain verification after obtaining the secret share and the public verification parameter in S330 can be avoided. The on-chain contract verifies whether the secret share and the corresponding public verification parameter match, to avoid a link of initiating a complaint to the contract again after a mismatching result is obtained when each node independently performs off-chain verification in S330, thereby saving at least one round of communication.

In S410, assume that each consensus node is honest and does not act maliciously. However, actually, there may be malicious behavior. For example, the consensus node generates and sends an incorrect secret share. For another example, the consensus node does not encrypt the secret share by using the public key of the receiver. If the consensus node does not encrypt the secret share by using the public key of the receiver, based on the embodiment in FIG. 8, verification by the on-chain contract can still succeed, but the receiver cannot correctly decrypt the encrypted secret share. If the consensus node generates and sends an incorrect secret share, the receiver possibly cannot perform decryption correctly. In this way, the solution is incomplete. To make the solution more complete, zero knowledge proof-related technology can be used, so that the code logic in the on-chain contract can further verify correctness of the secret share.

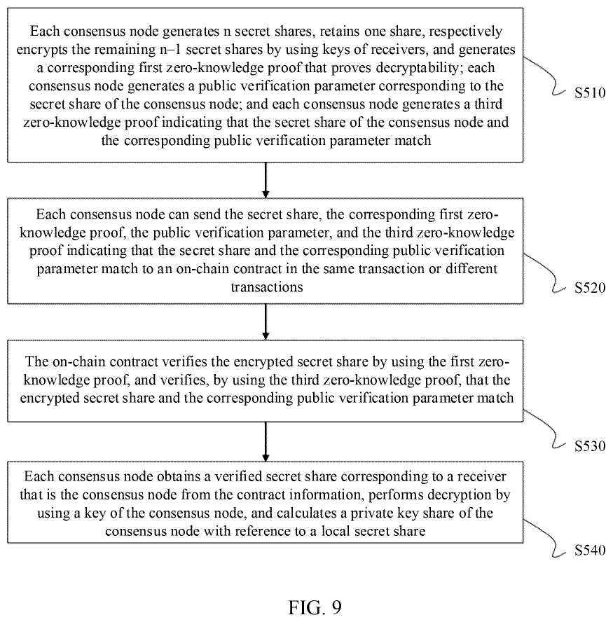

Based on this, this application provides a method for implementing distributed key generation in a blockchain. As shown in FIG. 9, the method includes the following steps.

S510: Each consensus node generates n secret shares, retains one share, respectively encrypts the remaining n−1 secret shares by using keys of receivers, and generates a corresponding first zero-knowledge proof that proves decryptability; each consensus node generates a public verification parameter corresponding to the secret share of the consensus node; and each consensus node generates a third zero-knowledge proof indicating that the secret share of the consensus node and the corresponding public verification parameter match.

Similar to S410, a node 1 can randomly select a group of numbers from a finite prime field as coefficients, that is, as a₁₀, a₁₁, and a₁₂. In this case, a generated polynomial is f₁(z)=a₁₀+a₁₁z+a₁₂z², where a₁₀ is a secret s₁ set by the node 1.

Similarly, a node 2 can randomly select a group of numbers from the same finite prime field as coefficients, that is, as a₂₀, a₂₁, and a₂₂. In this case, a generated polynomial is f₂(z)=a₂₀+a₂₁z+a₂₂z², where a₂₀ is a secret s₂ set by the node 2.

Similarly, a node 3 can randomly select a group of numbers from the same finite prime field as coefficients, that is, as a3₀, a₃₁, and a₃₂. In this case, a generated polynomial is f₃(z)=a₃₀+a₃₁z+a₃₂z², where a₃₀ is a secret s₃ set by the node 3.

Similarly, a node 4 can randomly select a group of numbers from the same finite prime field as coefficients, that is, as a₄₀, a₄₁, and a₄₂. In this case, a generated polynomial is f₄(z)=a₄₀+a₄₁z+a₄₂z², where a₄₀ is a secret s₄ set by the node 4.

Each node can further determine a group of secret shares based on the determined polynomial. The secret share can be determined based on the following formula by using the polynomial coefficient:

$${s}_{i j} = {f}_{i} ( j ) mod q ( j = 1 , … , n ) \qquad Formula ( 3 )$$

In the formula (3), q is the same large number used by each node, and is also referred to as an order, and an objective of performing a modulo operation on fᵢ(j) by using q is to limit a value of fᵢ(j) to a range of [0, q−1]. An example is as follows:

The node 1 generates four secret shares: S₁₁=f₁(1) mod q, S₁₂=f₁(2) mod q, S₁₃=f₁(3) mod q, and S₁₄=f₁(4) mod q.

The node 2 generates four secret shares: S₂₁=f₂(1) mod q, S₂₂=f₂(2) mod q, S₂₃=f₂(3) mod q, and S₂₄=f₂(4) mod q.

The node 3 generates four secret shares: S₃₁=f₃(1) mod q, S₃₂=f₃(2) mod q, S₃₃=f₃(3) mod q, and S₃₄=f₃(4) mod q.

The node 4 generates four secret shares: S₄₁=f₄(1) mod q, S₄₂=f₄(2) mod q, S₄₃=f₄(3) mod q, and S₄₄=f₄(4) mod q.

As described above, in S420, each consensus node sends the encrypted secret share to an on-chain contract by using a transaction. In this way, all nodes in a blockchain can obtain the encrypted secret share from the contract information. For example, any node can perform listening by using the above-mentioned event mechanism, to detect the encrypted secret share in msg of the event. To ensure that only a receiver that has a valid key can perform decryption, similar to S410, a sender can encrypt a corresponding secret share by using a public key of a receiver.

In addition, to avoid a case in which the receiver cannot perform decryption correctly because the consensus node generates and sends an incorrect secret share, and contract code logic needs to perform verification, a zero-knowledge proof can be used here. The zero-knowledge proof means that a prover can convince a verifier that a certain statement is correct without providing any useful information to the verifier. The zero-knowledge proof here is, for example, a range proof. The range proof is a zero-knowledge proof technology that proves a plaintext bit length range in a Pedersen commitment, and its function is to convince, by proving a length of a plaintext encrypted by a ciphertext, the verifier that the encrypted ciphertext is decryptable. For example, for a 32-bit ciphertext, a party that has a private key can quickly perform exhaustive decryption by creating a table. The Pederson commitment is a type of commitment in cryptography, and was proposed by Torben Pryds Pedersen in 1992. Currently, the Pedersen commitment is mainly used with elliptic curve cryptography (certainly can also be combined with exponential operations), and has a ciphertext form with strong binding and homomorphic addition characteristics based on a discrete logarithm problem.

When asymmetric encryption is used, Twisted ElGamal encryption can be used as an asymmetric encryption scheme to use the range proof. Twisted ElGamal is an additive homomorphic public key encryption scheme that is friendly to the zero-knowledge proof.

In Twisted ElGamal encryption, a decryption process involves a brute force algorithm in an exhaustive way. After an original binary text with a length exceeding 32 bits is encrypted, a relatively large quantity of bits need to be exhausted, and decryption cannot be performed within a proper time. The proper time is, for example, an order of milliseconds to seconds in a computer with ordinary computing power. For example, after an original binary text with a length of 64 bits is encrypted, it approximately takes several years to complete decryption, and 256 bits is even more of an astronomical number. After an original binary text with a length of 32 bits is encrypted, a decryption party that holds a corresponding private key can complete decryption in milliseconds.

Based on this, in encryption of sᵢⱼ, sᵢⱼ can be split into 32-bit segments.

By setting a value of the order q, a value range of sᵢⱼ can be limited to a uniform range. For example, if q is set to a prime number of 256 bits, the value range of sᵢⱼ can be limited to a range of 0 to 2²⁵⁶−1. In this way, a value of sᵢⱼ can be represented by a 256-bit binary number. Usually, the value of sᵢⱼ is set to 256 bits or larger to ensure security of the ciphertext, that is, ensure that a party that does not have a valid key cannot perform decryption within a proper time.

For a specified order q, a length of sᵢⱼ can be set to |q|. Here, | | represents an operation of selecting a quantity of bits of a binary number. For a number with a length of |q|, sᵢⱼ can be evenly split into m parts from the most significant bit to the least significant bit, and each part is a segment including |q|/m binary numbers. When each sᵢⱼ is 256 bits, sᵢⱼ can be split into eight 32-bit segments from the most significant bit to the least significant bit, and numbers from the most significant bit to the least significant bit (that is, from left to right) can be a seventh segment, a sixth segment, a fifth segment, a fourth segment, a third segment, a second segment, a first segment, and a zeroth segment.

Each segment of 32 bits is obtained through splitting, because the receiver can quickly decrypt the length of 32 bits for ECC-based asymmetric encryption, for example, perform decryption in an exhaustive way. However, the receiver cannot quickly decrypt 64 bits or a longer length within the scope of current ECC asymmetric encryption algorithms. Certainly, if q is set to a prime number of 32 bits, the value range of sᵢⱼ can be limited to a range of 0 to 2³²−1. In this way, the value of sᵢⱼ can be represented by using a 32-bit binary number. If the value of sᵢⱼ is represented by a binary number with a length of 32 bits, no segmentation is needed, as described above.

Then, the node i can encrypt each of the m binary numbers corresponding to the node i, to obtain a ciphertext C_{i,j,k}=(pkⱼ^{r}^{ₖ}, g^{r}^{ₖ}h^{s}^{_{i,j,k}}), where C represents a ciphertext, and subscripts i and j are the same as subscripts of sᵢⱼ, and indicate that a j^{th} secret share generated by the node i is to be sent to the node j. Here, k represents the above-mentioned segment number. For example, if the above-mentioned 256 bits is split into eight 32-bits segments from the most significant bit to the least significant bit, for the numbers from the most significant bit to the least significant bit (that is, from left to right), the seventh segment corresponds to a segment m=7, the sixth segment corresponds to a segment m=6, the fifth segment corresponds to a segment m=5, the fourth segment corresponds to a segment m=4, the third segment corresponds to a segment m=3, the second segment corresponds to a segment m=2, the first segment corresponds to a segment m=1, and the zeroth segment corresponds to a segment m=0. Here, h and g are the same, and both represent generators on a group. Here, r represents a random number, pkⱼ represents a public key of the node j, and the node j here serves as a secret receiver.

In C_{i,j,k}=(pkⱼ^{r}^{ₖ}, g^{r}^{ₖ}h^{s}^{_{i,j,k}}), a right side of the equal sign represents an encryption method, for example, Twisted ElGamal, that is, a mask operation is performed on g^{r}^{ₖ}h^{s}^{_{i,j,k}} by using pkⱼ^{r}^{ₖ}, which is equivalent to an encryption operation.

In this way, an original 256-bit text can be split into eight 32-bit segments by using Twisted ElGamal, eight ciphertexts are generated through encryption, and each ciphertext corresponds to one segment.

Correspondingly, the using a range proof can be specifically generating a range proof for each ciphertext. In this way, for the original 256-bit text, eight ciphertexts and eight corresponding range proofs are finally generated. The eight range proofs are set to RangeProof_{i,j,m}, where the subscript i represents a node number of a generator, j represents a node number of a receiver, and m represents a segment number. Here, m=0, 1, 2, . . . , 7.

As described above, Twisted ElGamal is an additive homomorphic public key encryption scheme that is friendly to the zero-knowledge proof. Based on the additive homomorphic characteristic, the eight ciphertexts and the eight corresponding range proofs can be superposed to generate one range proof, set to RangeProof_{i,j}. In addition, if a plurality of range proofs are superposed to generate one range proof, space occupied by the proof can be greatly reduced. If each proof in RangeProof_{i,j,m} occupies 100 bytes, the eight range proofs RangeProof_{i,j,0}, RangeProof_{i,j,1}, . . . , and RangeProof_{i,j,7} corresponding to the eight ciphertexts obtained after the ciphertext generated by the sender node i and corresponding to a receiver that is the node j is split occupy 800 bytes in total. However, based on the above-mentioned additive homomorphic characteristic, if the eight range proofs RangeProof_{i,j,0}, RangeProof_{i,j,1}, . . . , and RangeProof_{i,j,7} are combined into one range proof, that is, combined into RangeProof_{i,j}, combined RangeProof_{i,j} approximately occupies 200˜300 bytes, less than a half of 800 bytes, and a zero-knowledge proof characteristic is retained. That is, the combined range proof can still prove that each ciphertext segment of s_{i,j} is 32 bits, that is, is decryptable within a proper time. For example, a decryption party that holds a corresponding private key can complete decryption in milliseconds. Clearly, compared with a non-combined range proof, the combined range proof can reduce a size of a transaction sent to the blockchain, to reduce storage space needed for on-chain data.

In addition, each consensus node usually has a public key registered with the blockchain. In the above-mentioned Twisted ElGamal, the public key of the receiver is used for encryption. Correspondingly, the verifier, for example, the on-chain contract, can verify RangeProof^{i,j} and C_{i,j,k} by using the public key of the receiver registered with the blockchain. If the verification succeeds, it can be proved that decryption can be completed in milliseconds, and it can be further proved that encryption is performed by using a public key pkⱼ held by the decryption party. In this way, the smart contract in the blockchain can verify, without holding the private key of the decryption party, that the decryption party (that is, the receiver) holding the corresponding private key can perform decryption. Certainly, even if the plurality of range proofs are not superposed to generate one range proofs, but the plurality of range proofs are generated, the smart contract in the blockchain can verify, without holding the private key of the decryption party, that the decryption party (that is, the receiver) holding the corresponding private key decrypts each ciphertext within a proper time.

Different from a case in which the first zero-knowledge proof is not sent, the node here sends the first zero-knowledge proof proving that the sent secret share can be decrypted by the receiver to the on-chain contract, so that the code logic in the on-chain contract can verify correctness of the secret share. If the verification succeeds, the on-chain contract can determine that content sent by the sender is correct, and the receiver can definitely perform decryption correctly. Therefore, the above-mentioned complaint link can be subsequently avoided, and a quantity of rounds of interaction between the node and the on-chain contract is reduced.

Correspondingly, each consensus node can generate a public verification parameter Aᵢₖ, k=1, 2, . . . , t corresponding to the polynomial of the consensus node. As described above, Aᵢₖ=g^{a}^{ᵢₖ}. Because multiplication of the group of public verification parameters can be used to verify a point on a curve corresponding to the polynomial, and the generated public verification parameter is in the same form as the public key generated on ECC, that is, pubᵢ=Πₖ₌₀^{t}Aᵢₖ^{x}^{ᵢ}^{^{k}}, a result of the multiplication is also referred to as a public key. For xᵢ=i, pkᵢ=Πₖ₌₀^{t}Aᵢₖⁱ^{^{k}}.

When the total quantity of nodes is n=4 and the threshold w=3, that is, a degree of the polynomial is t=2, a public key of the node 1 is pub₁=A₁₀¹^{⁰}·A₁₁¹^{¹}·A₁₂¹^{²}=g^{a}^{₁₀}^{·1}^{⁰}·g^{a}^{₁₁}^{·1}^{¹}·g^{a}^{₁₂}^{·1}^{²}; a public key of the node 2 is pub₂=A₂₀²^{⁰}·A₂₁²^{¹}·A₂₂²^{²}=g^{a}^{₂₀}^{·2}^{⁰}·g^{a}^{₂₁}^{·2}^{¹}·g^{a}^{₂₂}^{·2}^{²}; a public key of the node 3 is pub₃=A₃₀³^{⁰}·A₃₁³^{¹}·A₃₂³^{²}=g^{a}^{₃₀}^{·3}^{⁰}·g^{a}^{₃₁}^{·3}^{¹}·g^{a}^{₃₂}^{·3}^{²}; and a public key of the node 4 is pub₄==A₄₀⁴^{⁰}·A₄₁⁴^{¹}·A₄₂⁴^{²}=g^{a}^{₄₀}^{·4}^{⁰}·g^{a}^{₄₁}^{·4}^{¹}·g^{a}^{₄₂}^{·4}^{²}.

Here, pkⱼ represents a public key of a node j. The public key pkⱼ is different from the public key pubᵢ. The public key pkⱼ represents a public key in a public-private key pair generated by each node, and can be referred to as a first public key here. The public key pubᵢ here represents a public key related to the polynomial generated by the node, and can be referred to as a second public key.

S520: Each consensus node can send the secret share, the corresponding first zero-knowledge proof, the public verification parameter, and the third zero-knowledge proof indicating that the secret share and the corresponding public verification parameter match to an on-chain contract in the same transaction or different transactions.

This step is similar to S420. Details are omitted for simplicity.

S530: The on-chain contract verifies the encrypted secret share by using the first zero-knowledge proof, and verifies, by using the third zero-knowledge proof, that the encrypted secret share and the corresponding public verification parameter match.

As described in S510, the on-chain contract can verify RangeProof_{i,j} and C_{i,j,k} based on the Twisted ElGamal algorithm by using the public key of the receiver registered with the blockchain. If the verification succeeds, it can be proved that the receiver can complete decryption in milliseconds, and it can be further proved that encryption is performed by using the public key pkⱼ held by the decryption party, that is, the receiver node holding the corresponding private key can perform decryption correctly.

Specifically, for the solution in which the range proof and Twisted ElGamal encryption are used, in encryption of sᵢⱼ, sᵢⱼ is split into 32-bit segments, as described above. In this way, an original 256-bit text can be split into eight 32-bit segments by using Twisted ElGamal, eight ciphertexts are generated through encryption, and each ciphertext corresponds to one segment. Correspondingly, the using a range proof can be specifically generating a range proof for each ciphertext, or can be superposing the eight ciphertexts and eight corresponding range proofs to generate one range proof. Correspondingly, in S530, the on-chain contract can verify, by verifying the range proof, that the receiver can perform decryption. For the 32-bit segments obtained by splitting sᵢⱼ, the ciphertext segments can be restored here, for example, shifted based on a segment location and then superposed. For example, the ciphertext segment 1 can be left shifted by 32 bits, the ciphertext segment 2 can be left shifted by 64 bits, the ciphertext segment 3 can be left shifted by 96 bits, the ciphertext segment 4 can be left shifted by 128 bits, the ciphertext segment 5 can be left shifted by 160 bits, the ciphertext segment 6 can be left shifted by 192 bits, the ciphertext segment 7 can be left shifted by 224 bits, and the ciphertext segment 0 does not need to be shifted or is left shifted by 0 bits. The shifted ciphertexts can be superposed and then combined, and the combined ciphertext and the combined range proof are verified. The above-mentioned verification can be expressed as follows:
Σₖ₌₀^{m-1}C_{i,j,k}²^{^{32·k}}=h^{f}^{ᵢ}^{(j)}·R, where R=g^{Σ}^{ₖ₌₀}^{^{m-1}}²^{^{32·k}}^{·r}^{ₖ}, (k=0, 1, 2, . . . , m−1). For the above-mentioned eight segments obtained through splitting, a value of m can be 0 to 7.

The verifying, by using the third zero-knowledge proof, that the encrypted secret share and the corresponding public verification parameter match is similar to that in S430. Details are omitted here for simplicity.

S540: Each consensus node obtains a verified secret share corresponding to a receiver that is the consensus node from the contract information, performs decryption by using a key of the consensus node, and calculates a private key share of the consensus node with reference to a local secret share.

This step is similar to S440. Details are omitted for simplicity.

The on-chain contract generates a total public key in S540. Therefore, in step S540 or a subsequent step, each consensus node can further obtain the total public key from the contract information. Certainly, each consensus node can alternatively obtain the public verification parameter from the contract information, and calculate the total public key based on the obtained public verification parameter.

In addition, for the solution in which the range proof and Twisted ElGamal encryption are used in S510, in encryption of sᵢⱼ, sᵢⱼ can be split into 32-bit segments, as described above. In this way, an original 256-bit text can be split into eight 32-bit segments by using Twisted ElGamal, eight ciphertexts are generated through encryption, and each ciphertext corresponds to one segment. Here, for example, eight segments with a length of 32 bits can be obtained through splitting by using Twisted ElGamal, eight ciphertexts are generated through encryption, and each ciphertext corresponds to one segment. In this case, the receiver node can obtain all ciphertext segments from the contract information, then concatenate the ciphertext segments by bits to obtain the ciphertext sent by each sender, and then obtain the private key share by using the method in the formula (7). Details are omitted for simplicity.

In the above-mentioned process, peer-to-peer broadcasting between nodes can be avoided, and the on-chain contract can verify whether each node acts maliciously. If there is no malicious action, the code logic in the on-chain contract can further verify the correctness of the secret share, and can verify that the encrypted secret share and the corresponding public verification parameter match. In this way, the verification and complaint process in S330 is omitted, and a process of interaction between each node and the on-chain contract is omitted, thereby reducing a quantity of interaction rounds.

Although consensus nodes are mentioned in a plurality of places above, a person skilled in the art knows that in some implementation objectives, there can alternatively be ordinary nodes or consensus nodes and non-consensus nodes, rather than exclusively consensus nodes.

A blockchain system according to this application is described below and includes several nodes.

Each node generates n secret shares, retains one share, and respectively encrypts the remaining n−1 secret shares by using keys of receivers; each node generates a public verification parameter corresponding to the secret share of the node; and each node generates a third zero-knowledge proof indicating that the secret share of the node and the corresponding public verification parameter match.

Each node sends the secret share, the public verification parameter, and the third zero-knowledge proof that are generated by the node to an on-chain contract by using the same transaction or different transactions.

The on-chain contract verifies, by using the third zero-knowledge proof, that the encrypted secret share and the corresponding public verification parameter match.

Each node obtains a verified secret share corresponding to a receiver that is the node from the contract information, performs decryption by using a key of the node, and calculates a private key share of the node with reference to a local secret share.

A blockchain system according to this application is described below and includes several nodes.

Each node generates n secret shares, retains one share, respectively encrypts the remaining n−1 secret shares by using keys of receivers, and generates a corresponding first zero-knowledge proof that proves decryptability; each node generates a public verification parameter corresponding to the secret share of the node; and each node generates a third zero-knowledge proof indicating that the secret share of the node and the corresponding public verification parameter match.

Each node can send the secret share, the corresponding first zero-knowledge proof, the public verification parameter, and the third zero-knowledge proof indicating that the secret share and the corresponding public verification parameter match to an on-chain contract in the same transaction or different transactions.

The on-chain contract verifies the encrypted secret share by using the first zero-knowledge proof, and verifies, by using the third zero-knowledge proof, that the encrypted secret share and the corresponding public verification parameter match.

Each node obtains a verified secret share corresponding to a receiver that is the node from the contract information, performs decryption by using a key of the node, and calculates a private key share of the node with reference to a local secret share.

A first node in a blockchain system according to this application is described below.

The first node generates n secret shares, retains one share, and respectively encrypts the remaining n−1 secret shares by using keys of receivers; the first node generates a public verification parameter corresponding to the secret share of the first node; and the first node generates a third zero-knowledge proof indicating that the secret share of the first node and the corresponding public verification parameter match.

The first node sends the secret share, the public verification parameter, and the third zero-knowledge proof that are generated by the first node to an on-chain contract by using the same transaction or different transactions.

The on-chain contract verifies, by using the third zero-knowledge proof, that the encrypted secret share and the corresponding public verification parameter match.

The first node obtains a verified secret share corresponding to a receiver that is the first node from the contract information, performs decryption by using a key of the first node, and calculates a private key share of the first node with reference to a local secret share.

A first node in a blockchain system according to this application is described below.

The first node generates n secret shares, retains one share, respectively encrypts the remaining n−1 secret shares by using keys of receivers, and generates a corresponding first zero-knowledge proof that proves decryptability; the first node generates a public verification parameter corresponding to the secret share of the first node; and the first node generates a third zero-knowledge proof indicating that the secret share of the first node and the corresponding public verification parameter match.

The first node can send the secret share, the corresponding first zero-knowledge proof, the public verification parameter, and the third zero-knowledge proof indicating that the secret share and the corresponding public verification parameter match to an on-chain contract in the same transaction or different transactions.

The on-chain contract verifies the encrypted secret share by using the first zero-knowledge proof, and verifies, by using the third zero-knowledge proof, that the encrypted secret share and the corresponding public verification parameter match.

The first node obtains a verified secret share corresponding to a receiver that is the first node from the contract information, performs decryption by using a key of the first node, and calculates a private key share of the first node with reference to a local secret share.

In the 1990s, whether a technical improvement is a hardware improvement (for example, an improvement to a circuit structure such as a diode, a transistor, or a switch) or a software improvement (an improvement to a method procedure) can be clearly distinguished. However, as technologies develop, current improvements to many method procedures can be considered as direct improvements to hardware circuit structures. Almost all designers program an improved method procedure into a hardware circuit, to obtain a corresponding hardware circuit structure. Therefore, an improvement to a method procedure can be implemented by using a hardware entity module. For example, a programmable logic device (PLD) (for example, a field programmable gate array (FPGA)) is such an integrated circuit, and a logical function of the PLD is determined by a user through device programming. The designer independently performs programming to “integrate” a digital system onto a PLD, without requesting a chip manufacturer to design and manufacture a dedicated integrated circuit chip. In addition, currently, instead of manually manufacturing an integrated circuit chip, such programming is mostly implemented by using “logic compiler” software. The “logic compiler” software is similar to a software compiler used to develop and write a program. Original code needs to be written in a particular programming language before being compiled. The language is referred to as a hardware description language (HDL). There are many HDLs such as the Advanced Boolean Expression Language (ABEL), the Altera Hardware Description Language (AHDL), Confluence, the Cornell University Programming Language (CUPL), HDCal, the Java Hardware Description Language (JHDL), Lava, Lola, MyHDL, PALASM, and the Ruby Hardware Description Language (RHDL). Currently, the Very-High-Speed Integrated Circuit Hardware Description Language (VHDL) and Verilog are most commonly used. It should also be clear to a person skilled in the art that a hardware circuit that implements a logical method procedure can be readily obtained once the method procedure is logically programmed by using the several hardware description languages described above and is programmed into an integrated circuit.

A controller can be implemented by using any appropriate method. For example, the controller can be a microprocessor or a processor, or a computer-readable medium that stores computer readable program code (such as software or firmware) that can be executed by the microprocessor or the processor, a logic gate, a switch, an application-specific integrated circuit (ASIC), a programmable logic controller, or an embedded microprocessor. Examples of the controller include but are not limited to the following microprocessors: ARC 625D, Atmel AT91SAM, Microchip PIC18F26K20, and Silicon Labs C8051F320. The memory controller can also be implemented as a part of control logic of a storage. A person skilled in the art also knows that in addition to implementing the controller by using only the computer-readable program code, logic programming can be performed on method steps to enable the controller to implement the same function in a form of a logic gate, a switch, an application-specific integrated circuit, a programmable logic controller, an embedded microcontroller, etc. Therefore, the controller can be considered as a hardware component, and an apparatus configured to implement various functions in the controller can also be considered as a structure in the hardware component. Alternatively, an apparatus configured to implement various functions can be considered as both a software module for implementing a method and a structure in a hardware component.

The systems, apparatuses, modules, or units described in the above-mentioned embodiments can be specifically implemented by a computer chip or an entity, or can be implemented by a product having a certain function. A typical implementation device is a server system. Certainly, this application does not exclude that with development of future computer technologies, a computer that implements a function of the above-mentioned embodiment can be, for example, a personal computer, a laptop computer, a vehicle-mounted man-machine interaction device, a cellular phone, a camera phone, a smartphone, a personal digital assistant, a media player, a navigation device, an e-mail device, a game console, a tablet computer, a wearable device, or a combination of any of these devices.

Although one or more embodiments of this specification provide the method operation steps described in the embodiments or flowcharts, more or fewer operation steps can be included based on conventional or non-creative means. A sequence of steps listed in one or more embodiments is merely one of various step execution sequences and does not indicate a sole execution sequence. In practice, when being executed by an apparatus or an end-user device product, the steps can be executed sequentially or in parallel (for example, by parallel processors or in a multi-thread processing environment, or even in a distributed data processing environment) based on the method shown in the embodiments or the accompanying drawings. The terms “include”, “comprise”, or any other variants thereof are intended to cover a non-exclusive inclusion, so that a process, a method, a product, or a device that includes a list of elements not only includes those elements but also includes other elements that are not expressly listed, or further includes elements inherent to such a process, method, product, or device. Without more constraints, the existence of additional identical or equivalent elements in the process, method, product or device that includes the elements is not excluded. For example, if words such as first and second are used to represent names, they do not represent any particular sequence.

For ease of description, the above-mentioned apparatuses are described separately by dividing functions into various modules. Certainly, during implementation of one or more embodiments of this specification, the functions of the modules can be implemented in same one or more pieces of software and/or hardware, or modules implementing a same function can be implemented by using a combination of a plurality of sub-modules or sub-units, etc. The described apparatus embodiments are merely examples. For example, division into the units is merely logical function division and there can be other division manners in actual implementation. For example, a plurality of units or components can be combined or integrated into another system, or some features may be ignored or not performed. In addition, the displayed or discussed mutual couplings or direct couplings or communication connections can be implemented by using some interfaces. The indirect couplings or communication connections between the apparatuses or units can be implemented in electronic, mechanical, or other forms.

The present invention is described with reference to a flowchart and/or a block diagram of a method, an apparatus (system), and a computer program product according to one or more embodiments of the present invention. It should be understood that each procedure and/or block in the flowcharts and/or the block diagrams and a combination of procedures and/or blocks in the flowcharts and/or the block diagrams can be implemented by using computer program instructions. These computer program instructions can be provided for a general-purpose computer, a dedicated computer, an embedded processor, or a processor of another programmable data processing device to generate a machine, so that the instructions executed by the computer or the processor of the another programmable data processing device generate an apparatus for implementing a specific function in one or more procedures in the flowcharts and/or in one or more blocks in the block diagrams.

Alternatively, these computer program instructions can be stored in a computer-readable storage that can instruct a computer or another programmable data processing device to work in a specific way, so that the instructions stored in the computer-readable storage generate an artifact that includes an instruction apparatus. The instruction apparatus implements a specific function in one or more procedures in the flowcharts and/or in one or more blocks in the block diagrams.

Alternatively, these computer program instructions can be loaded onto a computer or another programmable data processing device, so that a series of operations and steps are performed on the computer or the another programmable device, to generate computer-implemented processing. Therefore, the instructions executed on the computer or the another programmable device provide steps for implementing a specific function in one or more procedures in the flowcharts and/or in one or more blocks in the block diagrams.

In a typical configuration, a computing device includes one or more processors (CPUs), one or more input/output interfaces, one or more network interfaces, and one or more memories.

The memory can include a form such as a non-persistent memory, a random access memory (RAM), or a nonvolatile memory in a computer-readable medium, for example, a read-only memory (ROM) or a flash memory (flash RAM). The memory is an example of the computer-readable medium.

The computer-readable medium includes persistent, non-persistent, removable and non-removable media that can store information by using any method or technology. The information can be computer-readable instructions, a data structure, a program module, or other data. Examples of the computer storage medium include but are not limited to a phase change random access memory (PRAM), a static random access memory (SRAM), a dynamic random access memory (DRAM), another type of random access memory (RAM), a read-only memory (ROM), an electrically erasable programmable read-only memory (EEPROM), a flash memory or another memory technology, a compact disc read-only memory (CD-ROM), a digital versatile disc (DVD) or another optical storage, a cassette magnetic tape, a magnetic tape/magnetic disk storage, a graphene storage, another magnetic storage device, or any other non-transmission medium. The computer storage medium can be configured to store information that can be accessed by a computing device. Based on the definition in this specification, the computer-readable medium does not include transitory media such as a modulated data signal and carrier.

A person skilled in the art should understand that one or more embodiments of this specification can be provided as methods, systems, or computer program products. Therefore, the one or more embodiments of this specification can use a form of hardware only embodiments, software only embodiments, or embodiments with a combination of software and hardware. In addition, the one or more embodiments of this specification can use a form of a computer program product that is implemented on one or more computer-usable storage media (including but not limited to a disk storage, a CD-ROM, an optical storage, etc.) that include computer-usable program code.

The one or more embodiments of this specification can be described in the general context of computer-executable instructions executed by a computer, for example, a program module. Usually, the program module includes a routine, a program, an object, a component, a data structure, etc. for executing a specific task or implementing a specific abstract data type. The one or more embodiments of this specification can alternatively be practiced in distributed computing environments. In the distributed computing environments, tasks are executed by remote processing devices that are connected through a communication network. In the distributed computing environments, the program module can be located in both local and remote computer storage media including storage devices.

The embodiments of this specification are described in a progressive way. For the same or similar parts of the embodiments, mutual references can be made to the embodiments. Each embodiment focuses on a difference from other embodiments. Particularly, the system embodiments are basically similar to the method embodiments, and therefore are described briefly. For related parts, references can be made to some descriptions in the method embodiments. In the descriptions of this specification, descriptions of reference to terms such as “an embodiment”, “some embodiments”, “an example”, “a specific example”, or “some examples” mean that specific features, structures, materials, or characteristics described with reference to the embodiment or example are included in at least one embodiment or example of this specification. In this specification, illustrative expressions of the above-mentioned terms are not necessarily intended for the same embodiment or example. In addition, the described specific feature, structure, material, or characteristic can be combined in a proper way in any one or more embodiments or examples. In addition, a person skilled in the art can combine and associate different embodiments or examples and features of different embodiments or examples described in this specification, provided that the embodiments or examples and the features do not conflict with each other.

The above-mentioned descriptions are merely embodiments of one or more embodiments of this specification, and are not intended to limit one or more embodiments of this specification. A person skilled in the art can make various changes and variations to one or more embodiments of this specification. Any modifications, equivalent replacements, improvements, etc. made without departing from the spirit and principle of this specification shall fall within the scope of the claims.

1. A method for distributed key generation by a blockchain node, comprising:
generating n secret shares;
retaining a share and respectively encrypting a remaining n−1 secret shares by using keys of receivers;
generating a public verification parameter corresponding to a secret share of the blockchain node;
generating a zero-knowledge proof indicating that the secret share of the blockchain node and the public verification parameter match;
sending the secret share, the public verification parameter, and the zero-knowledge proof to an on-chain contract by using a transaction;
verifying, by the on-chain contract based on the zero-knowledge proof, that the encrypted secret share and the public verification parameter match;
obtaining, from contract information, a verified secret share corresponding to the blockchain node;
performing decryption by using a key of the blockchain node; and
calculating a private key share of the blockchain node based on a local secret share.

2. The method according to claim 1, wherein the zero-knowledge proof is generated based on a Sigma protocol.

3. The method according to claim 1, wherein the method further comprising:
generating, by the on-chain contract, a total public key based on the public verification parameter.

4. The method according to claim 3, wherein the method further comprising:
obtaining, from the on-chain contract, the total public key.

5. The method according to claim 1, wherein the method further comprising:
obtaining the public verification parameter from the contract information;
calculating a total public key based on the public verification parameter.

6. A method for distributed key generation by a blockchain node of a blockchain, comprising:
generating n secret shares;
retaining a share and respectively encrypting a remaining n−1 secret shares by using keys of receivers;
generating a first zero-knowledge proof for proving decryptability;
generating a public verification parameter corresponding to a secret share of the blockchain node;
generating a second zero-knowledge proof indicating that the secret share of the blockchain node and the public verification parameter match;
sending the secret share, the first zero-knowledge proof, the public verification parameter, and the second zero-knowledge proof indicating that the secret share and the corresponding public verification parameter match to an on-chain contract in a transaction;
verifying, by the on-chain contract based on the first zero-knowledge proof, the encrypted secret share;
verifying, based on the second zero-knowledge proof, that the encrypted secret share and the public verification parameter match;
obtaining, from contract information a verified secret share corresponding to the blockchain;
performing decryption by using a key of the blockchain node; and
calculating a private key share of the blockchain node based on a local secret share.

7. The method according to claim 6, wherein the method further comprising:
performing asymmetric encryption on the n−1 secret shares by using public keys of the receivers.

8. The method according to claim 7, wherein the first zero-knowledge proof is generated after performing the asymmetric encryption.

9. The method according to claim 7, wherein performing the asymmetric encryption comprises:
performing the asymmetric encryption based on a Twisted ElGamal algorithm.

10. The method according to claim 9, wherein performing the asymmetric encryption based on the Twisted ElGamal algorithm comprises:
splitting an original text into segments of 32 bits; and
performing encryption based on the Twisted ElGamal algorithm by using the public keys of the receivers to generate ciphertexts corresponding to the segments.

11. The method according to claim 10, wherein the first zero-knowledge proof comprises a range proof.

12. The method according to claim 11, wherein the range proof is a range proof for a ciphertext or all the ciphertext.

13. A blockchain system comprising a plurality of blockchain nodes of a blockchain, wherein each blockchain node comprises:
at least one processor; and
one or more memories coupled to the at least one processor and storing programming instructions for execution by the at least one processor to perform operations comprising:
generating n secret shares;
retaining a share and respectively encrypting a remaining n−1 secret shares by using keys of receivers;
generating a first zero-knowledge proof for proving decryptability;
generating a public verification parameter corresponding to a secret share of the blockchain node;
generating a second zero-knowledge proof indicating that the secret share of the blockchain node and the public verification parameter match;
sending the secret share, the first zero-knowledge proof, the public verification parameter, and the second zero-knowledge proof indicating that the secret share and the public verification parameter match to an on-chain contract in a transaction;
verifying, by the on-chain contract based on the first zero-knowledge proof, the encrypted secret share;
verifying, based on the second zero-knowledge proof, that the encrypted secret share and the corresponding public verification parameter match;
obtaining, from contract information a verified secret share corresponding to the blockchain;
performing decryption by using a key of the blockchain node; and
calculating a private key share of the blockchain node based on a local secret share.

14. The blockchain system according to claim 13, wherein the operations further comprising:
performing asymmetric encryption on the n−1 secret shares by using public keys of the receivers.

15. The blockchain system according to claim 14, wherein the first zero-knowledge proof is generated after performing the asymmetric encryption.

16. The blockchain system according to claim 14, wherein performing the asymmetric encryption comprises:
performing the asymmetric encryption based on a Twisted ElGamal algorithm.

17. The blockchain system according to claim 16, wherein performing the asymmetric encryption based on the Twisted ElGamal algorithm comprises:
splitting an original text into segments of 32 bits; and
performing encryption based on the Twisted ElGamal algorithm by using the public keys of the receivers to generate ciphertexts corresponding to the segments.

18. The blockchain system according to claim 17, wherein the first zero-knowledge proof comprises a range proof.

19. The blockchain system according to claim 18, wherein the range proof is a range proof for a ciphertext or all the ciphertext.
